(19) United States
(12) Patent Application Publication
(10) Pub. No.: US 2004/0168837 A1
(43) Pub. Date: Sep. 2, 2004

(54) Modular robotic platform

(75) Inventors: Francois Michaud, Rock-Forest (CA); Dominic Letourneau, Rock-Forest (CA); Martin Arsenault, Loretteville (CA); Yann Bergeron, Drummondville (CA); Richard Cadrin, Saint-Mathieu de Beloeil (CA); Frederic Gagnon, Jonquiere (CA); Marc-Antoine Legault, Saint-Jerome (CA); Mathieu Millette, Drummondville (CA); Jean-Francois Pare, Fleurimont (CA); Marie-Christine Tremblay, Jonquiere (CA); Serge Caron, Rock Forest (CA); Jonathan Bisson, Sherbrooke (CA); Pierre Lapage, Drummondville (CA); Yan Morin, Warwick (CA); Martin Deschambault, Val d' Or (CA); Hugues Rissmann, Montreal (CA)

Correspondence Address: TESTA, HURWITZ & THIBEAULT, LLP, HIGH STREET TOWER, 125 HIGH STREET, BOSTON, MA, 02110, US

(73) Assignee: Universite de Sherbrooke, Sherbrooke (CA)

(21) Appl. No.: 10/724,519

(22) Filed: Nov. 28, 2003

(30) Foreign Application Priority Data
Nov. 27, 2002 (CA) 2,412,815

(51) Int. Cl. B62D 55/00

(52) U.S. Cl. 180/9.46

(57) ABSTRACT

A modular robotic platform is provided having four legs mounted to a body. Each of the legs is mounted to the body via a steering assembly so as to pivot in a first plane relatively to the body. Each leg includes an endless track assembly having a first wheel, a drive system for driving the first wheel, a second wheel, an endless track for rotatably coupling the second wheel to the first wheel, and a track tensioning assembly for pivoting the leg in a second plane perpendicular to the first plane. Each leg includes a locomotion controller and a local environment recognition module. Synchronisation of the legs is achieved by a central controller, which gathers data information from each leg through a synchronisation bus. A coordination bus allows to exchange data information between different modules of the robotic platform, including the legs, the central control system and other systems or modules such as an energizing system, a pitch gauge system, etc. A communication protocol is used allowing each module to know which data messages carried on the communication buses are intended for it.

### FIELD OF THE INVENTION

The present invention relates to robotic platforms. More specifically, the present invention is concerned with a modular robotic platform.

### BACKGROUND OF THE INVENTION

More and more applications for robots and more specifically for mobile robotic platforms have seen the light in recent years across many domains of human activity, including industrial, military, household, services and scientific explorations.

Examples of robotic platforms can be found in the following United States patent documents: U.S. 2001/0,047,895 A1, U.S. Pat. Nos. 4,993,912, 6,263,989, 5,323,867, and 6,144,180.

U.S. patent application Publication No. 2001/0047895 A1, published on Dec. 6, 2001, naming De Fazio et aL as the inventors, and entitled “Wheeled Platforms”, concerns a robotic platform having a series of pairs of wheels parallel mounted in line. This robotic platform can get over obstacles by modifying the relative angle between the pairs of wheels. A first drawback of De Fazio platform is that its steering system is inaccurate. A second drawback is that rubbing the ground while turning, or during holonomic pivots abrades its wheels. Moreover, the platform is not configured to selectively elevate its main body from the ground. A fourth drawback is that the platform is dedicated to telepresence applications and is not configured to carry a load.

U.S. Pat. No. 4,993,912, issued to King et al. on Feb. 10, 1991 and entitled “Stair Climbing Robot” is directed to a robotic platform having three (3) pairs of drive wheels. The rotational axis of the front pair of wheels is fixedly mounted to the chassis of the platform. The rotational axis of the two back pairs of wheels are mounted at the end of a rotating arm that can pivot relatively to the chassis about an axis positioned at the center of the arm. King's robotic platform achieves to climb stairs by pivoting the rotating arm. A drawback of this robotic platform is that it is specialized in climbing stairs and is not configured for other complicated displacement.

In U.S. Pat. No. 6,263,989 B1, entitled “Robotic Platform” and issued on Jul. 24, 2001, Won describes a robotic platform using four (4) endless tracks to move. The first two tracks are located on each side of a main body. The two other tracks are so mounted at the front end of the platform as to be pivotable about the front drive wheels of the tracks. The pivoting of these front tracks allows the robot to get over obstacles and to climb stairs. A drawback of this robotic platform is that all the length of the first fixed tracks is rubbed on the ground during turns causing premature wear of the wheels coating. Also, the gaps between the treads of the tracks render the climbing irregular.

The U.S. Pat. No. 5323,867, issued to Griffin et al. on Jun. 28, 1994 and entitled “Robot Transport Platform With Multi-directional Wheels” teaches a robotic platform having three wheels on each side. The two central wheels are conventional, while the front and back wheels are multidirectional. The multidirectional wheels are provided with small balls so mounted on the wheels circumference as to be rotatable about an axis perpendicular to the rotation of the wheels, preventing the wheels from rubbing the ground during turn. This robotic platform achieves to solve the wheel or track-rubbing problem. However, the platform is not configured to perform complicated displacement including stairs climbing.

U.S. Pat. No. 6,144,180 issued on Nov. 7, 2000 to Chen et al. and entitled “Mobile Robot” describes a robotic platform comprising four legs so mounted to a chassis as tow provide two on each side. Each leg is a mixed between a wheel and leg and is mounted on a pivot that allows either to move a carried load from front to back or to switch the position of the front and back legs. This allows the platform to drive, to walk or to climb stairs. Drawbacks of Chen's robotic platform include an inaccurate steering system and the fact that the wheels rub the ground during turning.

A robotic platform free of the above-described drawback is thus desirable.

### OBJECTS OF THE INVENTION

An object of the present invention is therefore to provide an improved robotic platform.

### SUMMARY OF THE INVENTION

More specifically, in accordance with a first aspect of the present invention, there is provided a robotic platform comprising:

a body;

at least two locomotion members for moving the body; each of the at least two locomotion members being mounted to the body via a steering assembly so as to pivot in a first plane relatively to the body; each of the at least two locomotion members including an endless track assembly having a driving wheel, a drive system for driving the driving wheel, a driven wheel, an endless track for coupling the driven wheel to the driving wheel for rotation in unison, and a track tensioning assembly for pivoting the locomotion member in a second plane perpendicular to the first plane;

at least one controller mounted to the body and being coupled to the at least two locomotion members; the at least one controller being configured to actuate the movement of the at least two locomotion members; and

a power supply system mounted to the body and being coupled to the at least one controller for energizing the at least one controller and the at least two locomotion members.

According to a second aspect of the present invention, there is provided a track-tensioning assembly for pivoting an endless track assembly including a driving wheel about the driving wheel; the endless track assembly including, in addition to the driving wheel, a drive system for driving the driving wheel, a driven wheel, and an endless track for coupling the driven wheel to the driving wheel for rotation in unison; the track-tensioning assembly comprising:

a support frame having a ring portion and being mounted within the endless track between the driving wheel and the driven wheel; the driving wheel being rotatably received in the a ring portion of the support frame;

a driving mechanism for pivoting the support frame about the driving wheel, including an inner toothed gear secured to the support frame, a motor, having a driving shaft, mounted to the driving wheel via a mounting plate for driving the inner toothed gear, and a speed-reduction gear set for transmitting the rotational movement of the driving shaft of the motor to the inner-toothed gear.

According to a third aspect of the present invention, there is provided a robotic platform comprising:

a body;

a locomotion assembly mounted to the body for moving the body; the locomotion assembly including at least one locomotion member for displacement of the body and a steering assembly including a steering mechanism for steering the body; the at least one locomotion member including a drive assembly and a locomotion controller coupled to the drive assembly; the steering assembly including a steering controller coupled to the steering mechanism;

an environment recognition module mounted to the platform for gathering environment data indicative of the environment surrounding the robotic platform; the environment recognition module including a sensor and a recognition module controller coupled to the sensor;

an energizing module including a power supply controller and an energizing system connected to the locomotion assembly and the environment recognition module for energizing the locomotion assembly and the environment recognition module; and

a communication data bus interconnecting the at least one locomotion controller, the steering controller and the environment recognition module controller for communicating status data therebetween;

whereby, in operation, the locomotion controller, steering controller, recognition module controller, and power supply controller exchanging status data about the drive assembly, the steering assembly, the environment recognition module, and the energizing system via the communication data bus, and using the status data to control the drive assembly, the steering assembly, the environment recognition module, and the energizing system respectively.

According to a fourth aspect of the present invention, there is provided a method for controlling the modules of a robotic platform, each module including a system and a controller for the system, and each system including at least one sensor and one actuator, the method comprising:

coupling the modules through a communication data bus;

providing a central controller coupled to the modules via the communication data bus;

upon one of the modules sending a first data frame over the communication data bus, each the first data frame being characterized by the hardware address of the module to which the data frame is intended;

i) each of the modules filtering the first data frame to identify data frames intended thereto using the hardware address of the module to which the first data frame is intended;

ii) the central controller verifying whether the module to which the first data frame is intended to is activated or not;

iii) if the module to which the first data frame is intended to is activated then the module to which the data frame is intended to a) reading its at least one sensor, b) processing the command or query according to the reading, c) commanding its at least one actuator according to the processing, and d) transmitting a second data frame via the communication bus to the modules indicative of the command/query; and

iv) transmitting a second data frame indicative of the status of at least the module to which the first data frame is intended to.

A modular robotic platform according to the present invention can be used to transport many types of equipments, for various applications such as: maintenance task in environments such as a homes, buildings, shopping centers, exterior chores (lawn, asphalt, snow, water, ice, etc.), telepresence, construction, space exploration, military applications, life saving, airport, firefighting, etc.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1 is a perspective view of a modular robotic platform according to an illustrative embodiment of the present invention, including perspective views of the main components;

FIG. 2 is a top partially exploded view of the central body of the modular robotic platform from FIG. 1, illustrating internal components thereof;

FIG. 3 is a bottom partially exploded view of the central body of the modular robotic platform from FIG. 1, illustrating internal components thereof;

FIG. 4 is a top partially exploded view of the central body of the modular robotic platform similar to FIG. 1, illustrating external components thereof;

FIG. 5 is a top partially exploded view of the central body of the modular robotic platform similar to FIG. 1, illustrating the shell thereof;

FIG. 6 is an exploded view of the steering assembly of the modular robotic platform from FIG. 1;

FIG. 7 is an exploded view of the drive assembly of the robotic platform from FIG. 1;

FIG. 8 is a perspective view of the mounting assembly of the drive assembly from FIG. 7;

FIG. 9 is a partly sectional perspective view of the driving wheel actuator of the drive assembly from FIG. 7;

FIG. 10 is a partly sectional perspective view of the driving wheel support structure of the drive assembly from FIG. 7;

FIG. 11 is a perspective view of the endless track assembly of the robotic platform from FIG. 1;

FIG. 12 is an exploded view of the driving wheel from FIG. 11;

FIG. 13 is an exploded view of the driven wheel from FIG. 11;

FIG. 14 is a partly sectional perspective view of the track tensioning assembly driving mechanism of the drive assembly from FIG. 7;

FIGS. 15 and 15A are exploded views of the track-tensioning assembly of the robotic platform from FIG. 1, FIG. 15A illustrating the mounting of the driven wheel support of the track-tensioning assembly from FIG. 15;

FIG. 16 is a bloc diagram illustrating the general architecture of the controllers of the robotic platform from FIG. 1;

FIG. 17 is a schematic view illustrating the structure of a Control Area Network (CAN) frame as used to communicate information via the communication buses from FIG. 16;

FIG. 18 is a flowchart illustrating a method for controlling the modules of the robotic platform from FIGS. 1 and 16 according to an illustrative embodiment of a specific aspect of the present invention;

FIG. 19 is a bloc diagram illustrating the energizing system from FIG. 16;

FIG. 20 is a bloc diagram illustrating the locomotion controller from FIG. 16;

FIG. 21 is a bloc diagram illustrating the local environment recognition module from FIG. 16;

FIG. 22 is a bloc diagram illustrating the central control system from FIG. 16;

FIG. 23 is a bloc diagram illustrating the remote-control system from FIG. 16;

FIG. 24 is a bloc diagram illustrating the user-interface system from FIG. 16;

FIG. 25 is a bloc diagram illustrating the pitch-gauge system from FIG. 16;

FIG. 26 is a bloc diagram illustrating the computer system from FIG. 16;

FIG. 27 is a bloc diagram illustrating different operating modes of the robotic platform from FIG. 1;

FIGS. 28A and 28B are respectively perspective and top plan views of the robotic platform from FIG. 1, illustrated in the front-rear displacement configuration of FIG. 27;

FIG. 29 is a top plan view of the robotic platform from FIG. 1, illustrated in the sideways displacement configuration of FIG. 27;

FIGS. 30A and 30B are respectively perspective and top plan views of the robotic platform from FIG. 1, illustrated in the holonomic displacement configuration of FIG. 27;

FIG. 31 is a perspective view of the robotic platform from FIG. 1, illustrating the raised displacement configuration;

FIGS. 32A and 32B are respectively perspective and side elevation views of the robotic platform from FIG. 1, illustrated in the flat-track displacement configuration of FIG. 27; and

FIG. 33 is a top plan view illustrating different displacement modes of the robotic platform from FIG. 1, including transition therebetween.

### DETAILED DESCRIPTION OF THE INVENTION

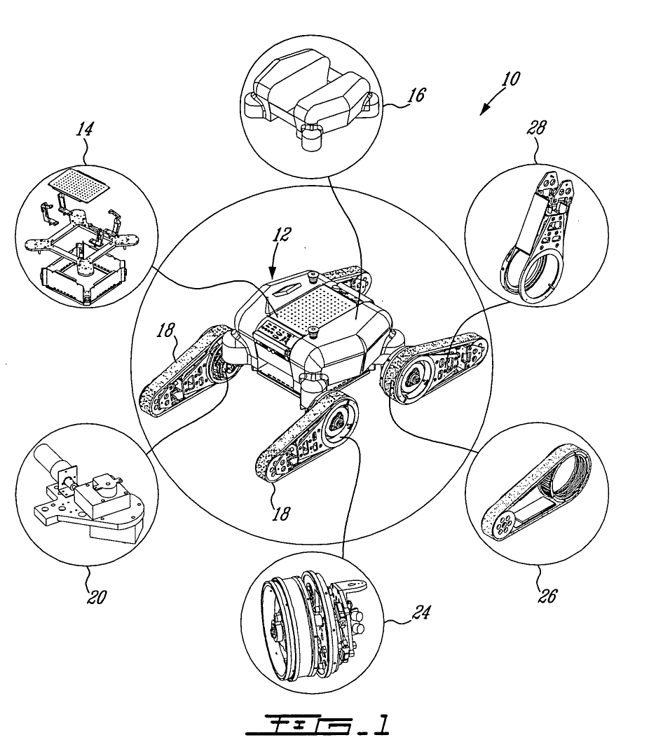

A modular robotic platform 10 in accordance with an illustrative embodiment of the present invention will now be described with reference to FIG. 1.

The robotic platform 10 comprises a body 12 including a chassis 14 and a shell 16, and a locomotion assembly including four locomotion members in the form of legs 18. Each leg 18 is mounted to the body 12 via a steering assembly 20 and includes a drive system 24, an endless track assembly 26 and a track-tensioning assembly 28.

The body 12, and more specifically the chassis 14, allows for mounting accessories (not shown) depending on the application of the robotic platform 10. It also allows mounting electrical and electronic components, such as controllers, as will be described hereinbelow.

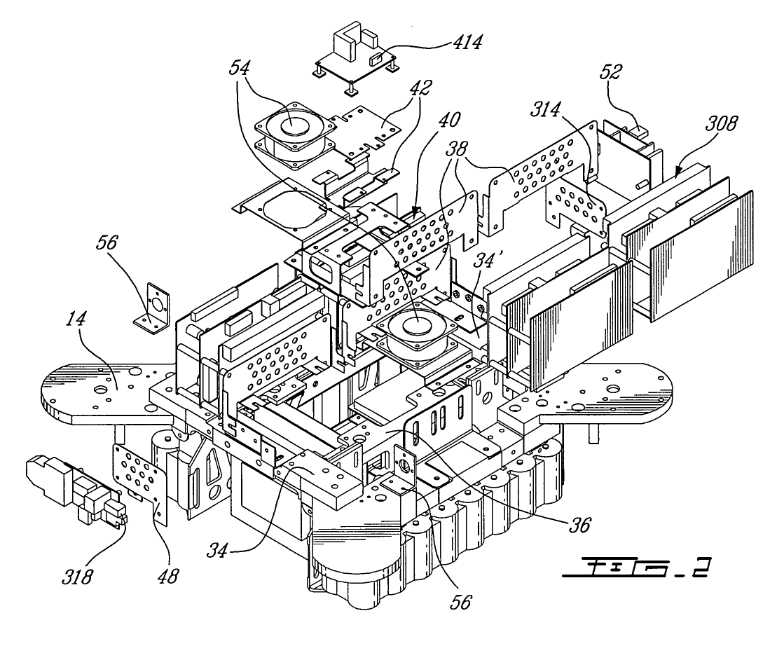

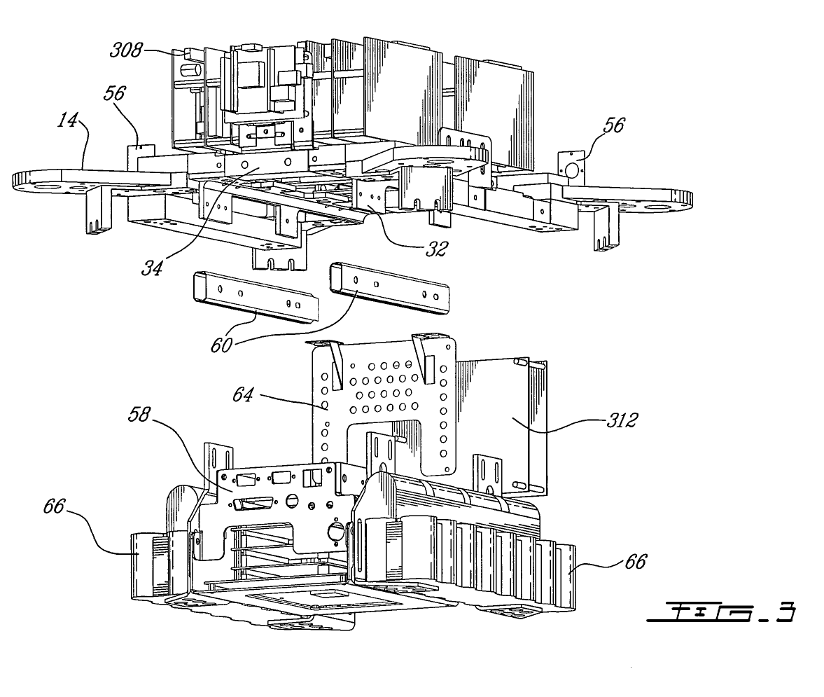

Referring now to FIGS. 2 and 3, the body 12 will be described in more detail. The chassis 14 of the body 12 includes a rectangular frame 30 and two angle irons 32 allowing securing internal components to the frame 30. The chassis 14 further comprises front and back structural members 34-34′ and a central structural member 36 on which plied steel brackets 38 are mounted. These plied steels brackets 38 allow for mounting locomotion controllers 308, one for each of the four legs 18. A support bracket 42 mounted to the central structural element fixedly receives a pitch gauge 414. A user-interface system in the form of a personal digital assistant (PDA) system interface 318 (see FIG. 16) is secured to the front structural member 34 via a mounting bracket 48. A remote control system 314 (see FIG. 16) is also secured to one of the plied steel bracket 38 via a mounting bracket 52. Two fans 54 are provided in the body 12 and are secured to opposite iron angles 32. Of course, the number and location of the fans 54 may vary.

Four brackets 56 secured to the chassis 14, near its four corners, allow receiving the motors 84 of the steering assembly 20. A casing 58 is provided to receive a central controller 312 (see FIG. 16). The casing 58 is mounted to the iron angles 32 via two precision ground ways 60. The body 12 includes a communication control system 312 secured to the iron angles 32 via a bracket 64. Finally, two batteries 66 are secured to the iron angles 32 via brackets. It is to be noted that the sets of batteries 66 have been mounted to the chassis 14 so as to be positioned as low as possible, yielding a low center of gravity for the body 12. Of course, the number of batteries 66 may vary. The access to the sets of batteries 66 and to the central controller 312 is facilitated by the configuration of the iron angles 32, ground ways 60, and lower shell portion 82.

It is to be noted that the expressions “batteries” should be construed in a broad sense encompassing any portable power source, including battery packs, fuel cells, portable batteries, etc.

The steering assembly 20, central controller 312, pitch gauge 414, PDA system interface 318, and remote control system 314 will be described in more detail hereinbelow.

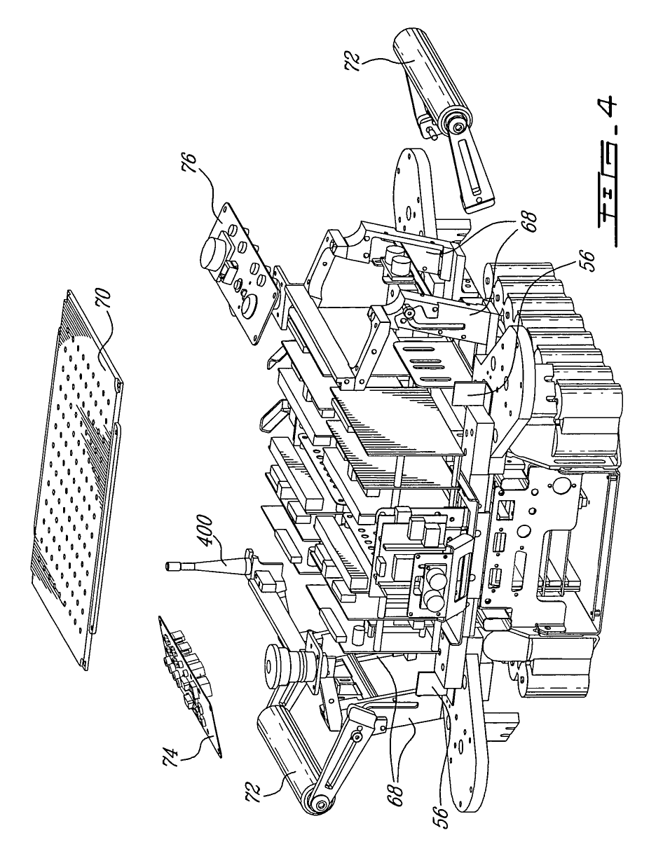

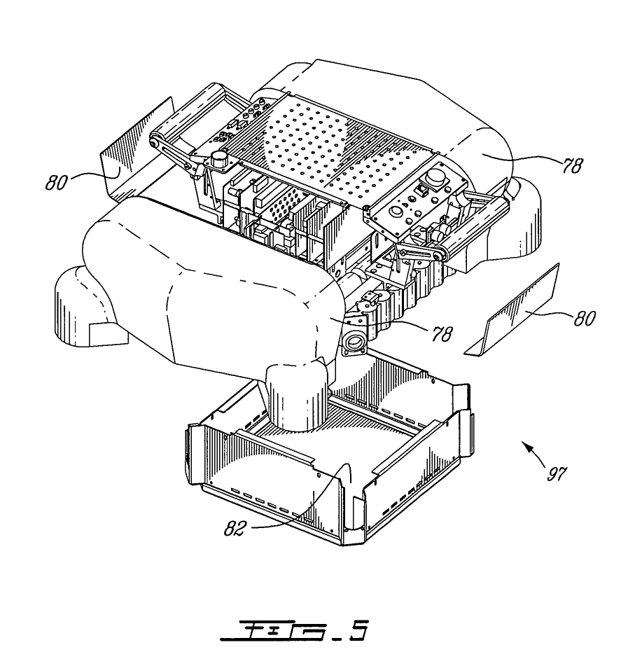

Turning now to FIGS. 4 and 5, external components of the body 12 will now be described.

The body 12 further includes four (4) rigid columns 68 secured to the chassis 14 near its four corners for securing external components of the body as will now be described.

A rectangular cover plate 70 is secured on top of the columns 68. The plate 70 allows receiving selected equipments (not shown) allowing the robot 10 to achieve specific tasks. Two handles 72 are also secured to the columns 68. The columns 68 also support two interface panels 74-76. A first interface panel 74 includes connections allowing connecting external modules on the CAN coordination buses 302-304 (see FIG. 16), power supply (5V, 12V), video input ports (4), audio jacks (in-out), RS-232 jacks. A second interface panel 76 includes the external power supply connector, main power switch, reset button, and status leds. The first interface panel 74 includes connecting means, such as video connectors 432, USB ports 434, and other connectors to connect equipments (not shown) to be mounted on the plate 70.

As illustrated in FIG. 5, a shell 16 that includes front and back portions 78, two side portions 80 and a bottom portion 82 protects the body 12. The shell portions 78-82 are secured to the chassis 14 and allow protecting the internal components. Since the shell 16 is divided in independent portions 78-82, each of these portions may act as a panel door allowing easy and fast access to a limited area of the internal parts of the body 12.

The chassis 14 and the other structural members of the body 12, including the different mounting brackets, are made of aluminum, of another rigid lightweight material or alternatively of any rigid material. Of course, in that later case, the resulting weight of the body 12 is increased, which may be detrimental to the autonomy of the platform 10.

Or course, the configuration and size of the chassis 14 and body 12 may vary depending, for example, on the application of the robotic platform, and on the configuration and number of the locomotion members 18. However, the configuration of the chassis 14 and more specifically the use of independent brackets for mounting the various controllers of the robotic platform 10 contribute to the modular configuration of the robotic platform 10 by allowing easy replacement of each module.

It is to be noted that the above-described internal and structural components of the body 12 are mounted therein so as to yield a body 12 as symmetrical as possible. This allows for a better stability and reliability of the overall robotic platform 10.

The chassis 14 and shell 16 are configured so that no electronic component is directly mounted to the shell 16. Also, the use of independent brackets to secure each electronic component allows simple and fast plugging and unplugging of each electronic component. The electronic components will be described hereinbelow in more detail.

It is to be noted that the frame 30 supports most of the components of the body 12.

The steering assembly 20 will now be described in more detail with reference to FIG. 6.

The steering effect of the steering assembly 20 is initiated by the direct current electric motor 84, which is secured to the chassis 14 via the bracket 56. The motor 84 includes a 10:1 reduction gear. The first rotatable shaft 87 of a worm-gear reducer 90 is operatively coupled to the motor 84 via a shaft coupling 88. The worm-gear reducer 90 is configured so as to provide a reducing ratio of 15:1 to a drive shaft 92. The drive shaft 92 allows triggering the optical encoder 94 and to drive a toothed gear 96 mounted fixedly mounted thereon. The drive shaft 92 is mounted at its proximate end into the worm-gear reducer 90 and at its distal end into a gear box 98 via deep groove ball bearings 100. The encoder 94 allows determining the angular position of the drive shaft 92.

A driven shaft 102 is mounted to both the chassis 14 and the gear box 98 therebetween so as to be generally parallel to the drive shaft 92. The driven shaft 102 is rotatably mounted to the chassis 14 and gear box 98 via deep groove ball bearings 104, which are sufficiently large to withstand the load resulting from the rotation of the locomotion member 18. A toothed gear 106 secured to the driven shaft 102 allows transmitting a rotational movement from the drive shaft 92 to the driven shaft 102. The respective number of teeth of gears 96 and 106 are chosen so as to yield a 2:1 reduction of speed from the gear 96 to the gear 106. This yields an overall reduction ration of 300:1 between the motor 84 and the driven shaft 102. Of course, the reduction gear of the motor 84, the worm-gear reducer 90 and the toothed gears 96 and 106 may be alternatively configured so as to yield a different overall reduction ratio depending on the application of the platform 10 and of the configuration and size of its locomotion members 18 for example.

A drive assembly mounting plate 109 of the drive system 24 is secured to the driven shaft 102 via a backing ring 108 so that pivoting the driven shaft 102 causes the pivoting of both the backing ring 108 and the mounting plate 109.

The use of an independent steering assembly 20 for steering each locomotion member 18 allows to better control the movement of the robotic platform 10. Moreover, the steering assembly 20 is configured so as to provide a lever effect.

Other work reducing means, such as planetary gear heads, harmonic drive gear heads, can also be used to provide the lever effect. Also, the optical encoder may be replaced by another pivot controlling means, such as rotary encoders, relative encoders, absolute encoder, synchro, resolver or LVDT converters, and potentiometers.

Alternatively to the motor 84 directly mounting the steering assembly 20 to the chassis 14, a pivoting shaft can be used providing an alternate motor to actuate the steering assembly 20. This alternate motor can be positioned within the steering assembly 20 or part of the legs 18 or in the body 12.

In some alternative embodiments of a robotic platform according to the present invention, only some of the locomotion members 18 may be provided with a motored steering assembly.

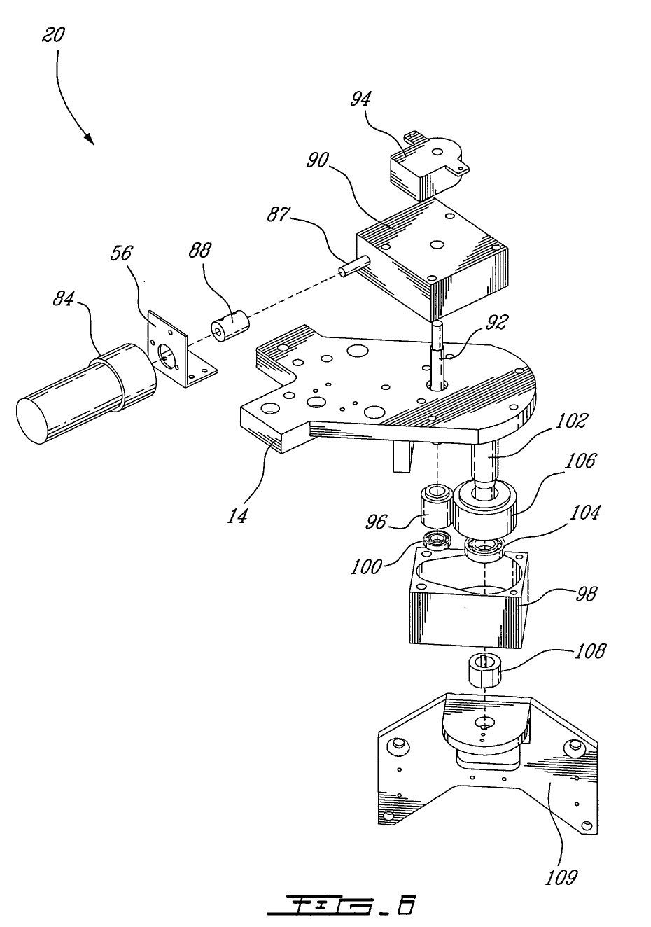

The drive system 24 of the drive assembly 22 will now be described in more detail with reference to FIGS. 7-11. The drive system 24 allows driving each leg 18 of the robotic platform 10 on a generally flat surface, on stairs or other broken grounds. The drive system 24 also allows controlling the track-tensioning assembly 28 in order to perform steps required in climbing a stair or to clear an obstacle. More specifically, the drive system 24 allows positioning and maintaining the track-tensioning assembly 28 to a selected angle with a precision of about one degree.

The drive system 24 includes two degrees of freedom: the drive speed, and the angle of the track-tensioning assembly 28.

As can be better seen in FIG. 7, the drive assembly 24 includes a mounting assembly 110, the driving wheel's actuator 112, the track-tensioning assembly driving mechanism 114, and the driving wheel support structure 116.

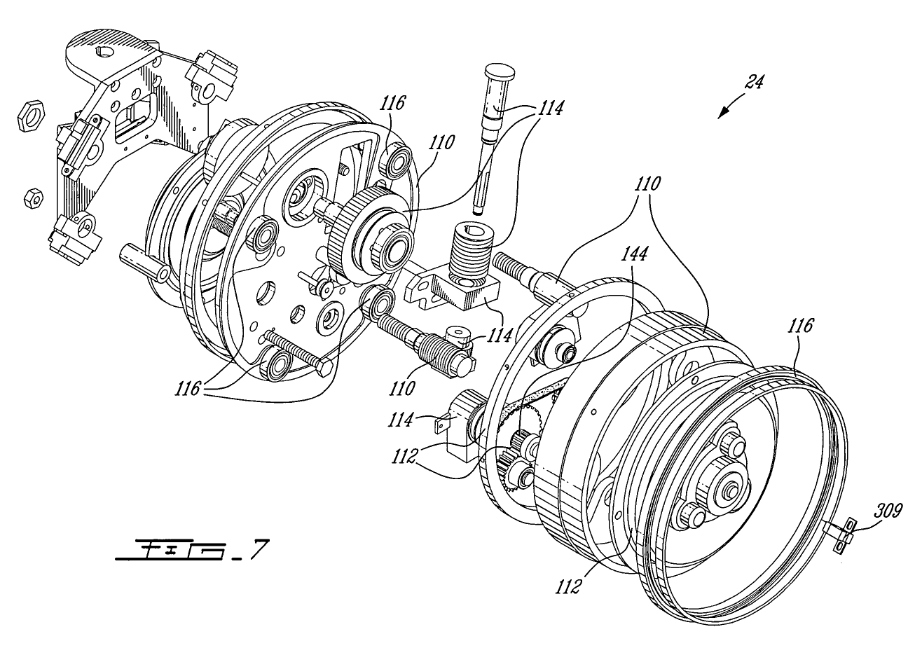

As can be better seen in FIG. 8, the mounting assembly 110 includes first and second mounting plates 118 and 120 secured to one another via rods 122-126. The two plates 118-120 include apertures having different shapes and sizes for mounting different components of the drive system 24 and the track-tensioning assembly 28 as will be described furtherin. As will also be explained hereinbelow, their respective peripheral surfaces 128-130 are also configured to receive some components of the drive system 24.

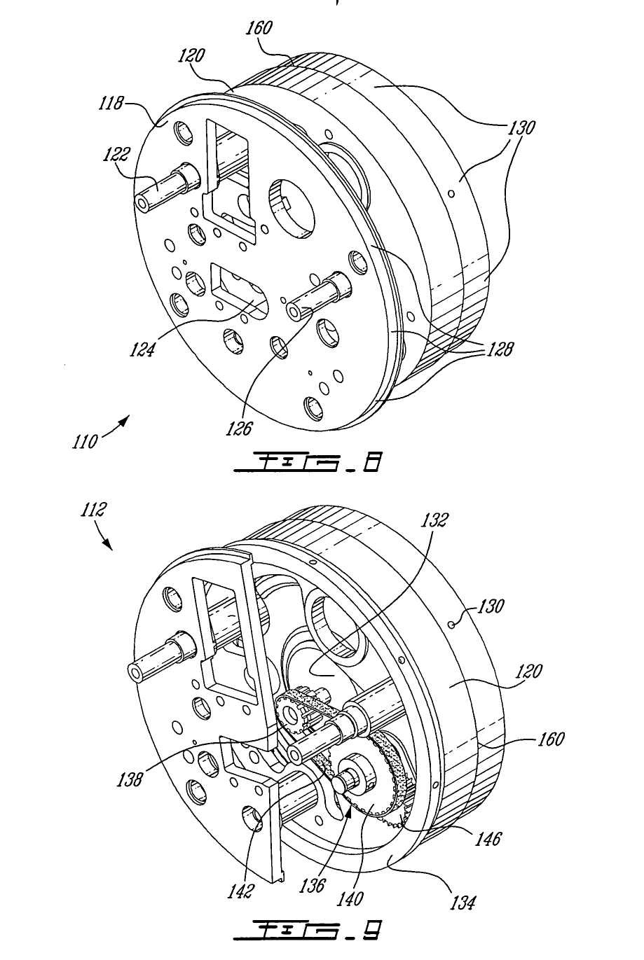

Turning now to FIG. 9, the driving wheel actuator 112 includes a motor 132 of the servo disc type which is mounted to the second mounting plate 120 on the side opposite the mounting first plate 118 via bolts or other mounting means. The driving wheel actuator 112 further includes an internally toothed gear 134 provided with inner-toothed gear so operatively coupled to the motor 132 via a pulley assembly 136 so that rotation of the driving shaft (not shown) of the motor 132 causes the rotation of the gear 134.

The pulley assembly 136 comprises a first gear 138 coaxially mounted to the driving shaft of the motor 132, a second gear 140 rotatably mounted to the first plate 118 and rotatably coupled to the first gear 138 via a belt 142. The cooperative arrangement between the pinion of the motor 132 and the internally-toothed gear 134 is completed by a third gear 144 (see on FIG. 7) fixedly and coaxially mounted to the second gear 140 so as to be rotatably mounted to the first plate 118, and a fourth gear 146 cooperatively coupled to both the third gear 144 and the internally-toothed 134. Alternatively, other pulley assembly 136 and drive wheel actuator 112 can be used to actuate the internally toothed gear 134 from the pinion of the motor 132. The pulley assembly can be replaced by an harmonic drive. Of course, the driving actuator 112 includes a driving wheel encoder for controlling the driving wheel actuator 112.

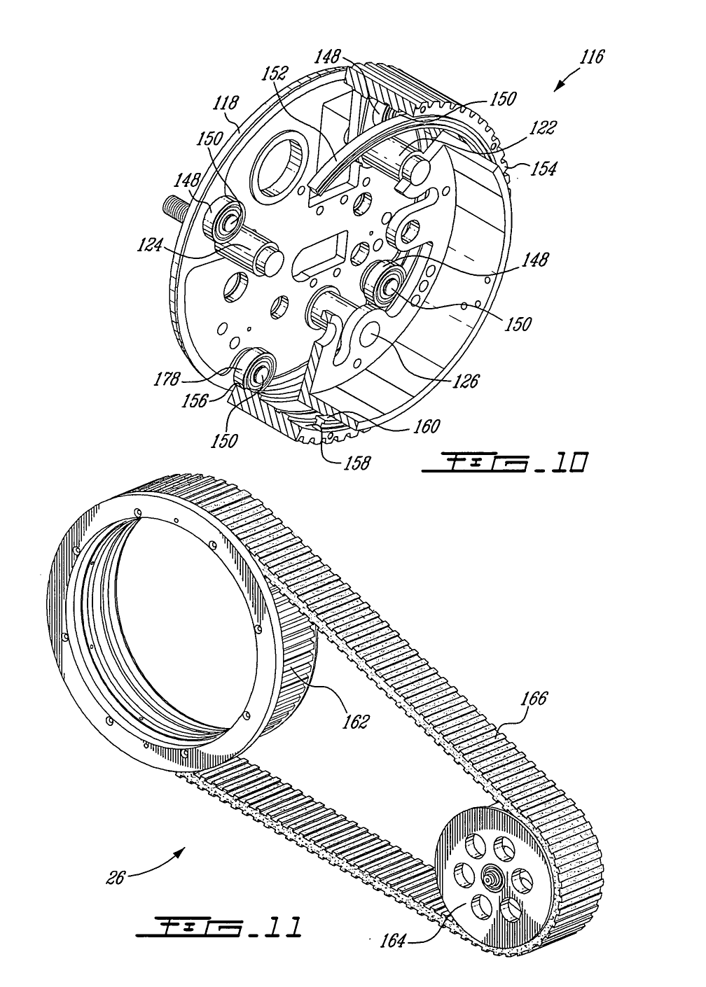

As illustrated in FIG. 10, the driving wheel support structure 116 comprises four ball bearings 148 that are mounted to the first plate 118 via four rods 150, and a large diameter bearing 152 having a thin thickness and being positioned between the drive gear 154 and the peripheral surface 130 of the second plate 120. As can be seen from FIG. 10, the drive gear 154 includes a first notch 156 having a width sufficient to receive the ball bearings 148 in abutment, and a second notch 158 positioned so as to be abutted by the large diameter bearing 152. As can be also seen from FIGS. 8 and 9, the second plate 120 is also provided with a notch 160 for receiving the large diameter bearing 152. Of course, the bearing 148 with corresponding rod 150 and the notches 156-160 are configured and sized so as to receive the drive gear 154 in a snuggly manner. The number and radial positions of the ball bearings 148 and corresponding rods 150 may vary.

The drive system 24 is configured so as to be relatively thin so as to be included in each leg 18.

Turning now to FIG. 11, the endless track assembly 26 will now be described in more detail. The endless track assembly 26 includes a driving wheel 162, a driven wheel 164, and an endless track 166. As can be seen from FIG. 11, the driving wheel 162 has a diameter greater then the driven wheel 164. Alternatively, the driven wheel 164 may has a diameter superior than the driving wheel's.

The endless track 162 comprises a series of regular grooves on its inner side surface to be engaged by the outer peripheral surface of the driving gear 154 and a patterned coating on its outer ground-engaging surface.

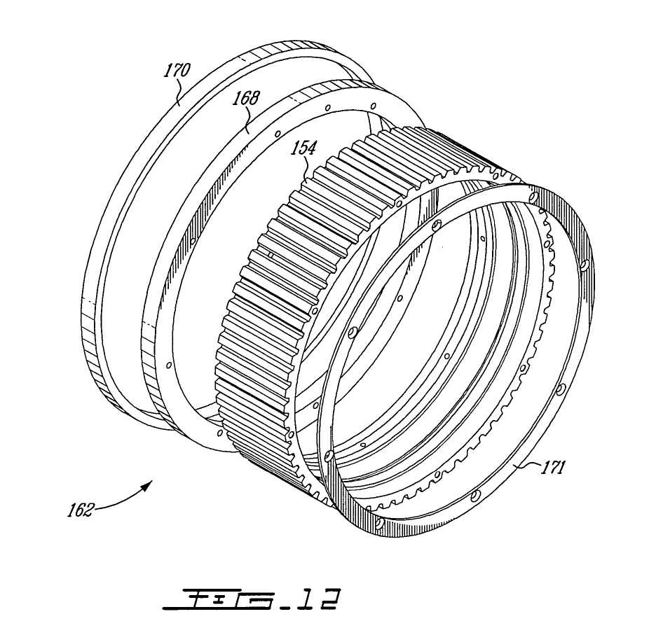

With reference now to FIG. 12, the driving wheel 162 comprises the driving gear 154, an attach-bearing 168, a coating 170 for the attach-bearing 168, and an attach guidance 171.

The attach-bearing 168 is secured to the driving gear 154 on the periphery thereof. The attach-bearing acts as a protective disk mounted and is therefore mounted on the outer peripheral surface of the driving gear 154 so as to extend radially therefrom. In operation, when the robotic platform 10 moves on a generally flat ground surface and leans only on the driving wheel 162, the bearing point of the driving wheel 162 is on the attach-bearing, allowing minimizing friction between the track 166 and the ground. The attach-bearing 168 is covered by the coating 170 to minimize tearing of the bearing surfaces. The attach guidance 171 allows guiding the track 154, preventing the track 154 from contacting the track-tensioning assembly 28.

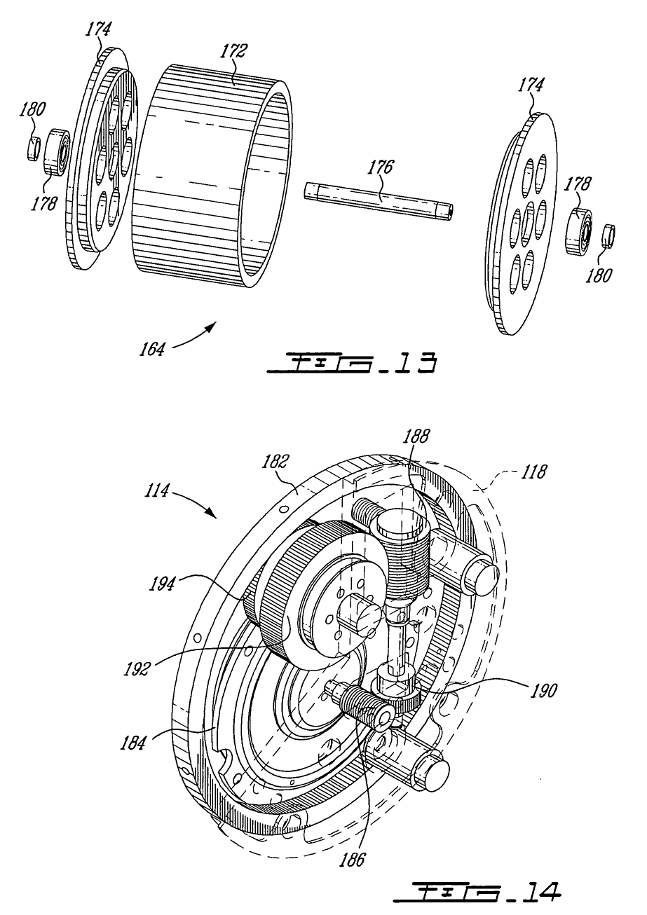

Referring now to FIG. 13, the driven wheel 164 comprises a cylinder 172 closed at its two longitudinal ends by round clamping plates 174 including shoulders for limiting the axial displacement of the endless track 166. The driven wheel 164 is made rotatable about a shaft 176 fixedly mounted to plates 214 of the track tensioning assembly 28 therebetween by mounting the clamping plates 174 to the shaft 176 via ball bearings 178. Two rings 180 mounted to the shaft 176 are used to limit the axial displacement of the internal rings of the ball bearings 178.

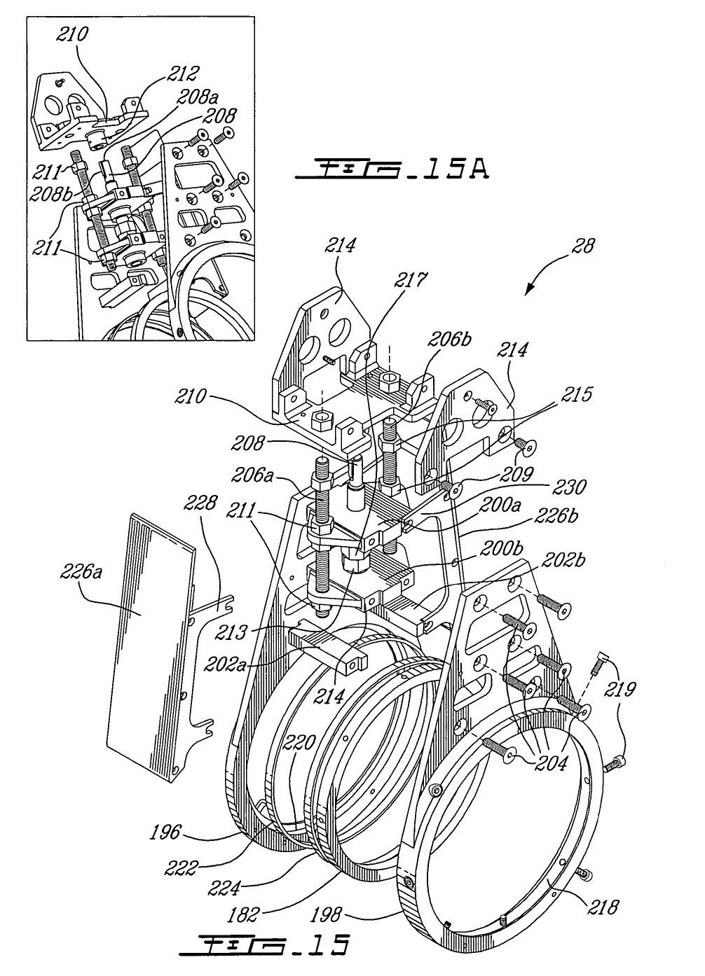

FIG. 14 illustrates the driving mechanism 114 of the track tensioning assembly. The driving mechanism 114 includes an inner toothed gear 182 secured to the track-tensioning assembly 28, a servo-disk motor 184 mounted to the plate 118 for driving the gear 182, and a speed-reduction gear set for transmitting the rotational movement of the motor 184 to the gear 182.

The speed-reduction gear set comprises two intermediate worm gears 186 and 188; a worm gear 190 and straight toothed gears 192-194. An intermediate gear 195 directly mounted unto straight gear 192 allows coupling the worm gear 188 to the straight gear 192.

As will easily be understood by one skilled in the art, the arrangement of the speed-reduction gear set causes the self-locking of the track-tensioning assembly 28 when the motor 184 stops. It is to be noted that other self-locking gear arrangement could be used to interconnect the motor 184 to the gear 182. Alternatively, other transmission means, such as an harmonic drive can be used.

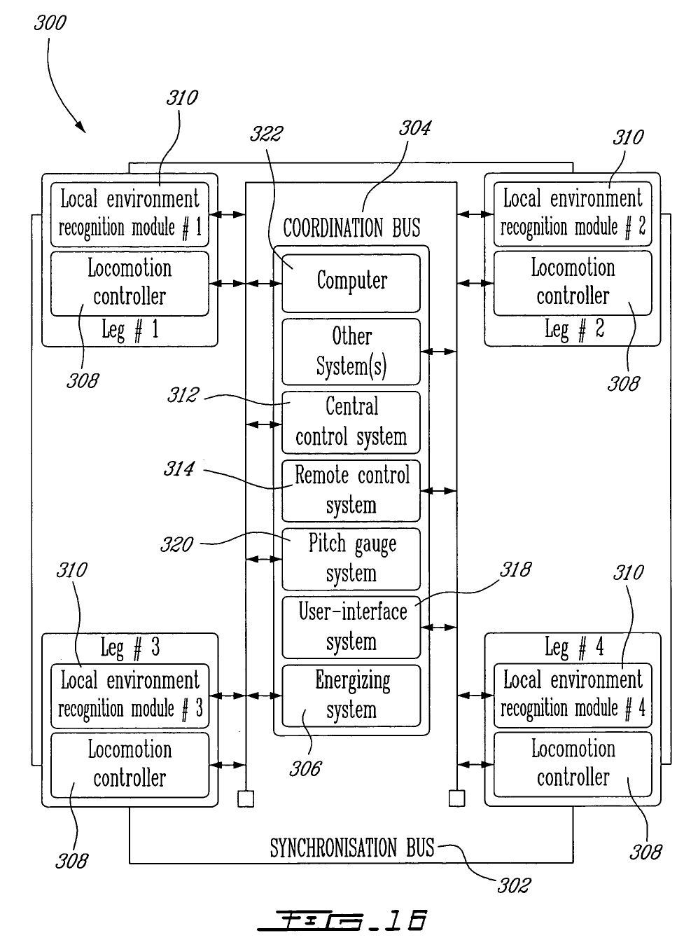

The track-tensioning assembly 28 will now be described with reference to FIGS. 15-15 A. The track-tensioning assembly 28 is used to support and position the driven wheel 164 while providing a rigid link between the driving and driven wheels 162-164 that supplies the track tension.

As illustrated in FIG. 15, the track-tensioning assembly 28 includes first and second main supports 196 and 198 interconnected via blocks 200a and 200b and via plates 202a and 202b. Fasteners 204 are used to removably mount the blocks and plates to the main supports.

A tensioning sub-assembly, defined by threaded rods 206a, 206b and 208 and associated nuts 211, 213 and 215, is mounted to the plates 200a and 200b. As shown in FIG. 15A, the end 208a of the adjustment threaded rod 208 has a keyway 208b and is engaged to the underside of the driven wheel support 210 provided with a corresponding key 212. Rotation of the rod 208 is therefore prevented. Accordingly, rotation of the main nut 213 will move the driven wheel support 210 outwardly, therefore increasing the tension on the track (not shown in this figure for clarity reasons). Nut 217 allows preventing the main nut 213 from loosing under vibration or others.

Plates 214 are part of the driven wheel support 210 and are used to support the shaft 176 of the driven wheel 164 (see FIG. 13). The plates 214 are secured to the driven wheel support 210 via fastening means such as screws 209. Plates 214, together with plate 210, form a driven wheel-mounting bracket.

Contacts between the track tensioning assembly 28 and the drive system 24 are achieved via the inner tooth gear 182 (see FIG. 14) that is radially fastened to a smooth part 218, which is part of the main support 198, using screws 219 or other fasteners. The main support 198 also includes a smooth part 220. Circular friction reducing disks 222 and 224 are mounted to the smooth parts 218 and 220, respectively. The inner surfaces of the circular friction reducing disk 222-224 rest respectively on the outer surface 128-130 (see FIG. 8).

Skid plates 226a and 226b are mounted to the track tensioning assembly 28 via brackets 228 and 230, respectively, to support the track 166.

Even though, the illustrative embodiment of the track-tensioning assembly 28 has been illustrated with screws and bolts as fasteners, other fastening means such as brackets or soldering may alternatively be used.

The general architecture 300 of the controllers of the robotic platform 10 will now be described with reference to FIG. 16.

Contrarily to conventional robots, which include a single central processing unit to which all the sensors and actuators are connected, a modular robotic platform 10 according to the illustrative embodiment of the present invention includes dedicated sub-systems (or modules) communicating through a common data communication bus. Indeed, each sub-system includes its own processor.

The terms module and system should be construed herein the same way, i.e. referring to a components of the robotic platform having its own controller and being configured to communicate with the other modules or systems.

According to the illustrated embodiment, the Control Area Network (CAN) version 2.0B protocol is used to communicate via the communication data buses. The data communication speed achieved using this protocol is one (1) Megabit per second. The communication protocol allows managing, sending and receiving messages between modules via the communication buses, managing errors and messages priority. Furthermore, any module configured to communicate through the CAN protocol can be added to the platform 10 without requiring complicated wiring and re-wiring between modules. Since the CAN protocol is believed to be well known in the art, it will not be described herein in more detail. Of course, other protocol can alternatively be used to communicate information among the modules, such as Ethernet, I2C, RS-232.

The modules illustrated in FIG. 16 are interconnected via the communication bus 304 one after the other (daisy chain) or in a star configuration, allowing to disconnect any module without affecting the others.

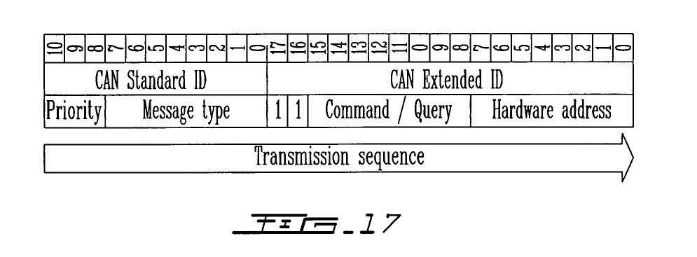

As it is commonly known among people skilled in the art, CAN data frame includes 7 parts: a Start of Frame (SOF) bit, a thirty-bits arbitration field, a six-bit control field, a data field being zero to eight octet long, a 16-bits Cyclic Redundancy Check (CRC) field, a two-bits ACK field, and a seven-bits end-of-frame field. Among those fields, the arbitration field and the data field have been adapted for the specific needs of the robotic platform 10. More specifically, FIG. 17 shows the structure of the arbitration field in a frame dedicated for communication via the coordination and synchronisation buses 302-304. The structure of FIG. 17 allows to prioritise communication messages in breaking the field into four components:

priority: each frame is characterized by a priority. According to the illustrative embodiment of FIG. 17, this priority ranges between 0 and 7 (over 3 bits). The priority “0” is the highest priority, “7” being the lowest priority;

message type: each frame is characterized as being part of one of eight message types. These message types are organized according to their importance and allow each module to characterized the outgoing message according to its priority. Table 1 summarizes the different types of messages that can be sent throughout the platform 10. The “message type” part of a frame is configured to facilitate filtering of the frames;

| Type (en binaire) | Description |
|---|---|
| 0000 0001 (0x01) | Emergency query |
| 0000 0010 (0x02) | High-priority actuator |
| 0000 0100 (0x04) | High-priority sensor |
| 0000 1000 (0x08) | Low-priority actuator |
| 0001 0000 (0x10) | Low-priority sensor |
| 0010 0000 (0x20) | Unused (free) |
| 0100 0000 (0x40) | Unused (free) |
| 1000 0000 (0x80) | Events |

command/query: each module can receive commands or information queries. For example, using 8 bits for this part of the frame, a module can receive 256 different commands/queries. The commands/queries are determined for each module depending on the processing power of its controller;

hardware address: each module has its unique hardware address that is used to communicate with the controllers of other modules. For example, using 8 bits for this part of the frame, there can be 255 modules to the robotic platform 10. This allows each module to determine if a frame is intended to its attention. A predetermined address, such as “255”, may be dedicated to message broadcasted to all modules.

Alternatively, other protocol can also be used to communicate data information over the communication data bus. It is to be noted that the number or functions of the modules may vary depending on the configuration and/or functions of the robotic platform.

Returning to FIG. 16, two communication data buses are used: a first bus 302 dedicated to the synchronisation of the movements of the legs 18; and a second bus 304 dedicated to the exchange of queries and data between the different modules. Alternatively, the number of communication data buses may differ. For example, only one communication data bus might be configured and used so as to allow both coordination and synchronisation.

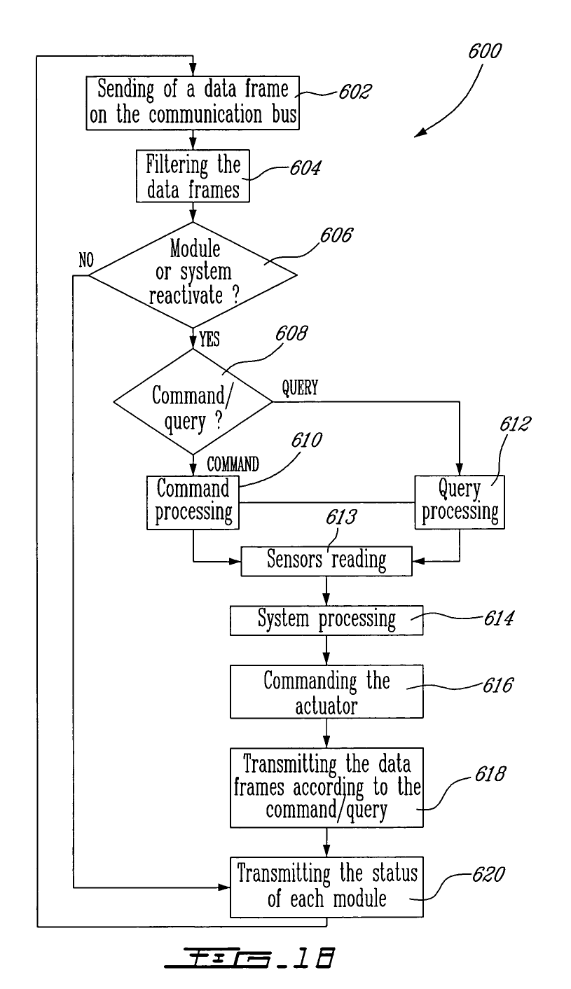

A method 600 for controlling the modules of the robotic platform 10 according to a specific aspect of the present invention will now be described with reference to FIG. 18.

In step 602, a data frame is sent through the communication bus 302 or 304 by one of the robotic platform's modules, including the locomotion controllers 308, the central control system 312, the local environment recognition modules 310, etc.

In step 604 a filtering is performed of the data frames according to the hardware address of the modules and the type of message carried by the data frames. Indeed, each module/system controller includes a predetermined and characteristic hardware address, allowing targeting each message sent by a module to specific modules. Specialized CAN controllers having filtering & masking capabilities for data frames can perform this step.

Then, it is verified if the module to which the message carried by the data frame is intended to is activated or not (step 606 ). A module is considered activated when it is in an operable state and when it can communicate through at least one of the data buses 302-304.

Even though the module is deactivated, it transmits its status through the data buses 302-304. This allows the central control system 312 to know which of the module are connected to the coordination bus 304. The central control system 312 is configured to activate and deactivate any module according to the operation mode, as will be described hereinbelow in more detail. The system is implicitly safe since, by default, the modules are in a deactivated state. It is to be noted that the expression “status data” will refer to herein as any data related to a module that is carried via one of the two communication buses 302-304, including but not limited to the position of a module's device, data gathered by a module's device, activation or deactivation state of a module's device, etc.

Next, the query or command is processed (steps 608 and 610 or 612 respectively). The sensors are then read in step 613 and the system processes the sensors reading in step 616.

The actuators of the modules are then commanded (step 616) according to the system processing and the data frames are transmitted depending on the command/query (step 618).

Finally, in step 620, the status of each module is transmitted via the communication bus. The cycle (from step 602 to 620) is repeated at a 100 Hz frequency. Of course, the clocking frequency may differ depending on the number of modules in the platform or the configuration and nature of the hardware for example.

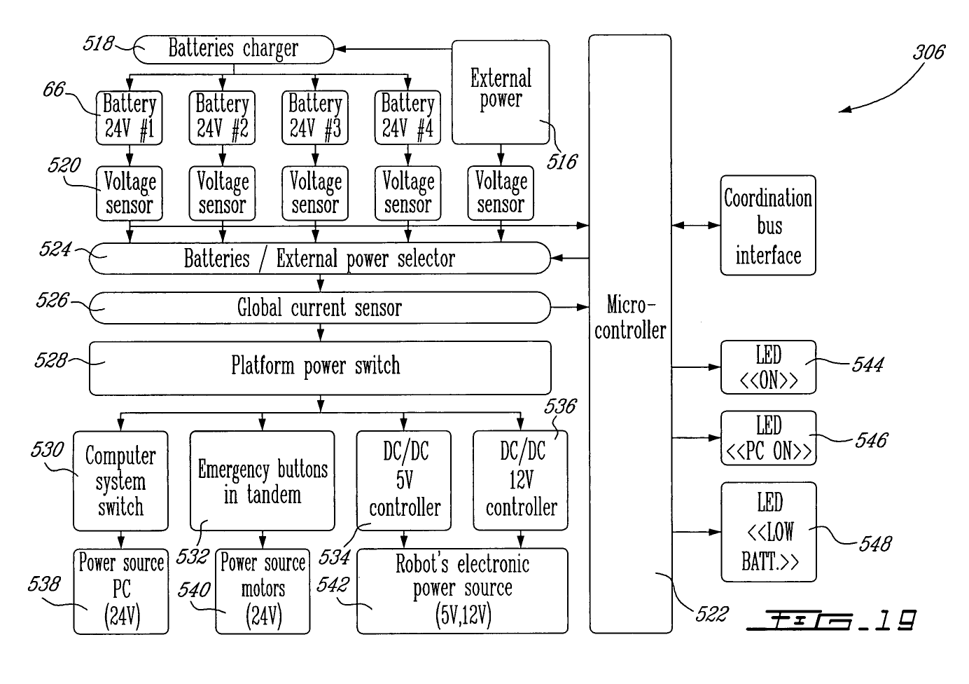

The energizing system 306 will now be described in more detail with reference to FIG. 19.

The energizing system 306 includes four (4) 24V batteries 66 that may include many cells. The robotic platform 10 is operable on batteries 66 or on an external power source 516. According to the illustrative embodiment, the external power source provides 500 W. Of course, the batteries 66 or the external power source 516 may provide other power and tension levels depending on the configuration of the platform 10 and its application. The energizing system 306 is so configured that all batteries 66 are disconnected as soon as an external source is detected by the system 306. This allows saving the batteries” charge. The energizing system 306 may be configured so that the external power source 516 charges the batteries 66 while energizing the robotic platform 10. However, in this case, the batteries charger 518 is provided on the platform 10.

The voltage sensor 520 allows measuring the tension at the external power source 516 or batteries' terminals. The micro-controller 522 periodically reads the voltage sensors 520 to assess the operational status of every battery 66 and of the external source 516.

Using the batteries/external power source selector 524, the micro-controller 522 may select the power source to use. This allows managing the batteries consumption. A battery 66 not working properly is disconnected by the micro-controller 522.

The global current sensor 526 feed to the micro-controller 522 the electrical current used by any one of the robotic platform's modules, in order to compute the overall power consumption of the platform 10.

The platform power switch 528 allows energizing or shutting off the robotic platform 10. A button or a key (not shown) may be used to activate the switch 528.

The robotic platform 10 comprises an energizing system 306 configured to manage the power feeding through the other module and mechanical components of the platform 10 from the sets of batteries 66 or from another external or internal power source (not shown). The power feeding management includes verifying the power level of the batteries 66, the available power from the different sources, and switching between external power source and the set of batteries 66. Since, all the robotic platform power distribution originates from the energizing system 306, this allows to shut off the power from a single source as a safety feature.

The robotic platform 10 includes two (2) or more emergency buttons 532 allowing cutting the power of the motors 84, 132, 184 if at least one button is depressed. For increased safety, the buttons 532 stay depressed and the robotic platform 10 stays immobilize unless a user repositions the buttons 532.

The DC/DC 5V 50 W controller 534 feeds to 5V all the electronic modules of the platform 10. The DC/DC 12V 50 W controller 536 feeds to 12V all the electronic modules of the platform 10.

The micro-controller 522 is configured to manage the electrical consumption of the robot 10 by selecting which of the batteries 66 to use, measure the voltage and current in the robot 10 for computing the instantaneous power at every computing cycle. At any time, the micro-controller 522 can receive a query from the central control system 322 via the coordination bus 304 to provide the power level of any battery 66 or the instantaneous power, and to acknowledge if the switches are closed. Integrating instantaneous power over time by the micro-controller 522 gives the energy consumption.

The computer system 322 includes its own power controller 538 directly powered by the batteries 66 via the computer system switch 530.

The motors 84, 132, and 184 are powered directly by the batteries 66 via 24V power controllers 540.

The energizing system 306 further includes two connectors including four wires (5V, 12V, ground, reset) that are available to power additional electrical systems (not shown) part, for example, of the equipments that can be carried by the robotic platform 10.

Finally, the energizing system 306 comprises three (3) LEDs (Light Emitting Diode) 544-548 that are located on the display panel 76 (see FIG. 4):

LED “ON” 544: this diode serves to indicate that the robot 10 is in operation;

LED “PC ON” 546: this diode serves to indicate that the computer 322 is energized; and

LED “LOW BATTERY” 548: this diode serves to indicate that the battery level is low.

Of course, the configuration of the energizing system 396 may vary without departing from the spirit and nature of the present invention.

Returning to FIG. 16, the modular robotic platform 10 further comprises four locomotion controllers 308, for controlling each of the four legs 18 independently. More specifically, the locomotion controller 308 is configured to control the three following motors of the locomotion members 18: the drive motor 132, the steering motor 84 and the motor 184 of the track-tensioning assembly 28.

More specifically, the locomotion controller 308 is in the form of an electronic board including a micro-controller (both not shown) connected to two other electronic boards dedicated to manage the power supply of the motors 84, 132, and 184, to read the steering assembly (direction) position encoder 94 (see FIG. 6), and the limit switches 309 (see FIG. 7) of each leg 18. Each locomotion controller 308 allows controlling the motors 84, 132, and 184 to provide a selected speed, acceleration, and position of the corresponding leg 18. The data related to the speed, acceleration and position of each leg 18 is communicated to the other locomotion controller 308 via the synchronisation bus 302.

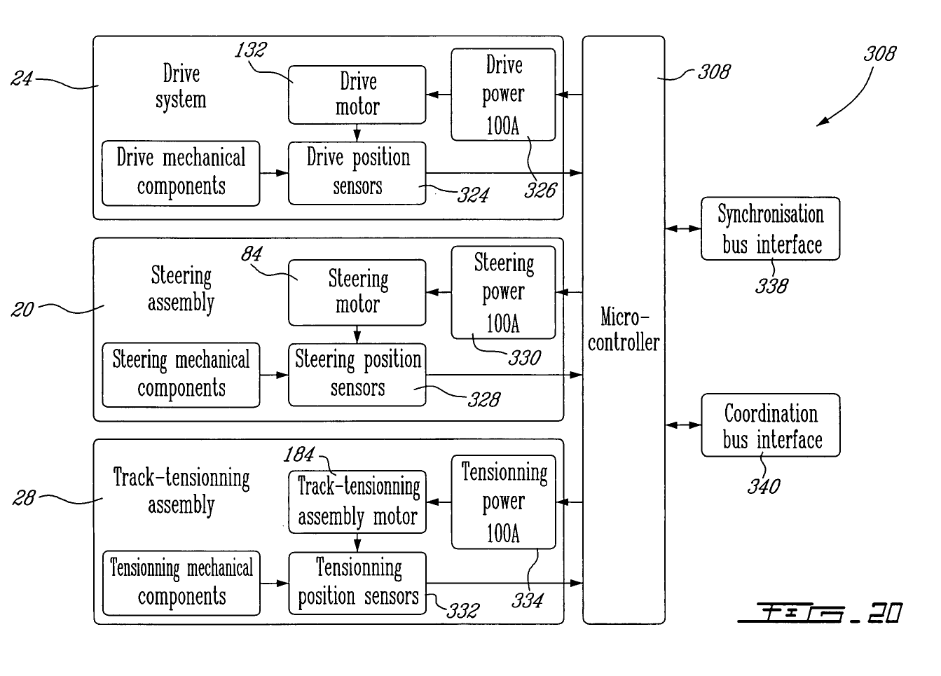

More specifically, with reference now to FIG. 20, each locomotion controller 308 comprises three power systems: a first one for the drive system 24, a second one for the steering assembly 20 and a third one for the track-tensioning assembly 28. Each of these three power systems allows controlling and powering specific motors of a leg 18. According to the illustrative embodiment of FIG. 20, the maximum current for each motor of 100 A.

The position sensors 324, 328, and 332 include three types of sensors: position encoders, optical sensors, and the limit switches. Optical sensors mounted to the steering assembly and to the tensioning assemblies are used to assess the initial position of the systems, acting similarly to limit switches. More specifically, the initial position is determined when a strip (not shown) cut the infrared beam of the optical sensor.

The position encoder of each motors 84, 132, and 184 are connected to an external counter (not shown). This counter increases or decreases depending on the direction of rotation of the motor. The external counter is connected to the micro-controller 336, allowing the locomotion controller 308 to query the counter. Other sensors may also be included to the platform 10.

Power sources 326, 330, and 334 are in the form of motor power circuits providing 100 A to each motors 84, 132, and 184. The motor power circuits are connected to the locomotion controller 308. This allows the locomotion controller 308 to measure the current in each motor 84, 132, and 184 and to detect whenever a motor is stalled, unplugged, etc.

The locomotion controller 308 is connected to the two communication buses 302-304 via respective bus interfaces 338-340. As mentioned hereinabove, the coordination bus 304 (see FIG. 16) manages communication among all modules of the platform 10. Indeed, the central control system 312 can send commands pertaining to the angular position, the speed, and the acceleration, to the locomotion controllers 308. The synchronisation bus 338 manages the synchronisation of the legs 18. The locomotion controller uses the synchronisation bus 302 for the simultaneous automatic control of the motors 84, 132, and 184 of the four legs 18.

Alternatively, independent controller may be provided for each motor 84, 132, or 184.

Each leg 18 further includes an environment recognition module 310 mounted to the local recognition controller 308 (see FIG. 2) for managing proximity sensors (not shown) mounted to each leg 18. More specifically, each leg 18 includes ultra-sound sensors (not shown), infrared sensors (not shown) and circuit breakers (not shown). Of course, the configuration, number and type of sensor used may vary.

The environment recognition module 310 will now be described in more detail with reference to FIG. 21.

Each module 310 includes proximity sensors 342-348 to detect objects in the vicinity of the platform 10. Many sensors configurations may be used so as to yield an appropriate field of vision for the robotic platform 10 by effectively positioning sensors on the legs 18 or by using other sensors such as cameras, heat sensors, luminosity sensors, laser, lidar, etc.

Using a combination of long and short-range sensors allows detecting remote objects while providing a good precision for object near the platform 10. Moreover, using both wide-angle sonars and short-angle infrared sensors allows identifying the position of objects. While some sensors are positioned on the shell 16, most of the sensors are positioned on the legs 18 to provide a field of view in the direction of the displacement of the platform 10. Moreover, since each leg 18 is movable, it is possible to orient a leg 18 in the direction of an object for inspection for example. Short and long-range, wide and narrow field of view, and fixed and mobile selection logics 358 are provided for the local environment recognition of the platform 10.

The short-range sensors mounted on the front 342-344 and on the back 346-348 of each leg 18 move with the steering assembly 20. Since these sensors are mounted to the legs 18 so as to detect objects or obstacles in a vertical plane, moving the leg 18 with the steering assembly 20 allows observing the environment in three dimensions. The micro-controller 360 periodically queries these sensors 342-348 to evaluate distances.

The long-range sensors 350-352 are mounted under the body 12 of the robotic platform 10. They allow detecting obstacles and objects located at a certain distance from the platform 10 and are therefore blind to the short-range sensors 342-348. The micro-controller 360 periodically also queries these sensors 350-352 to evaluate distances.

The contact switch 354 allows detecting collision with the robotic platform 10. They are mounted on any part of the platform 10.

The selection logic 358 allows the micro-controller 360 to activate one or more sensor at a time so as to minimize interferences therebetween. The micro-controller 360 receives commands/queries from the central control system 312 and forwards to the central control system 312 distance values from the short and long-range sensors 342-352, the status of the contact switch 354 and information related to the which sensor are activated.

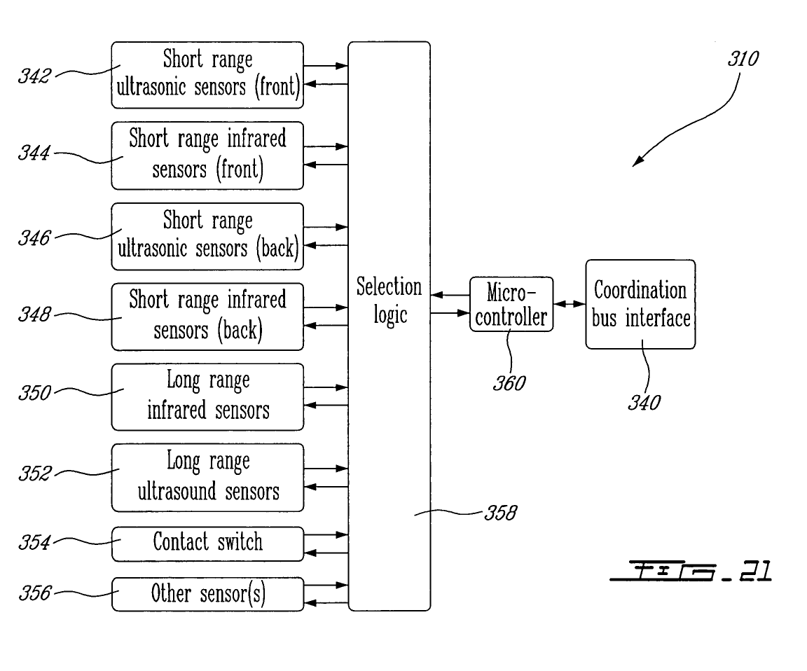

Turning now to FIG. 22, the central control system 312 will now be described in more detail. The central control system 312 is configured to receive information from the different modules illustrated in FIG. 16 and coordinates the behaviour and movements of the robotic platform 10. The central control system 312 is configured to receive queries concerning the displacement of the robot 10 in a specific mode, and to send commands to each locomotion member 18 to achieve that mode.

The micro-controller 364 is coupled to the different modules via the coordination bus 304 and the coordination bus interface 340. The micro-controller 364 is programmed to coordinate the different modules of the robotic platform 10 and to control the operation of the robotic platform 10 under different operational modes that will be described hereinbelow in more detail. Operational modes have been simulated using a three-dimensional model of the platform 10 before being integrated in the micro-controller 364.

The micro-controller 364 of the central control system 312 is configured so as to:

send messages related to the query and configuration of the local environment recognition module 310 of each leg 18 so as to obtain distance evaluation from the sensors 342-352 for example;

send messages related to the query and the configuration of the locomotion controller 308 of each legs 18 so as to control the position, speed and acceleration of each leg 18;

send messages related to the query and the configuration of the energizing system 306 so as to activate or deactivate the batteries 66, read the central current of the robot 10, read the energy consumption and the energy available and verify if the emergency buttons 532 are depressed;

send activation messages from each module;

periodically receive (at about every 50 ms) messages related to the status of each module; and

receive messages from the remote-control system 314 that sends periodically the status of all its command buttons.

The central control system 312 further comprises a LED identified “Alive” to signal a user that the platform 10 is efficiently operational. This LED is mounted to the panel 76 (see FIG. 4).

Supplemental LEDs 370 may also be provided to indicate the efficient operation of specific components of the platform 10.

Of course, other information display means may alternatively be provided instead of the LEDs 368-370.

Emergency buttons 372 connected to the micro-controller 364 are located at each corner of the body 12 and more specifically on the shell 16. The micro-controller 364 is configured to detect if any buttons 372 are depressed and then to initiate predetermined safety actions such as cutting the power to the motors. Emergency CAN messages can also be sent, requiring actions from different systems according to the situation.

Alternatively, the functions of the central control system 312 may be embedded in some of the other modules such as in the onboard computer system 322 for example.

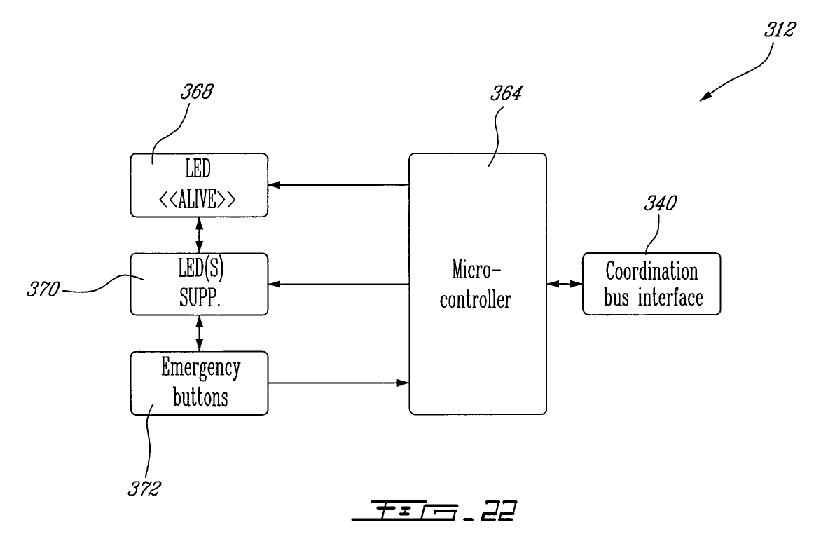

Turning now to FIG. 23, the remote-control system 316 comprises two (2) sub-systems: a remote control 374 and a receiver 376 mounted to the body 12 of the robotic platform 10. The remote control 374 comprises a power source in the form of rechargeable batteries 378. Even though 4 AA batteries providing 4.8V are used in the illustrated embodiment, the remote-control 374 can be configured so as to be powered by other types of batteries. Of course, single-use batteries can also be used.

A switch 380 allows to selectively energizing the remote control 374. A voltage doubler 382 allows to raise the batteries output to 9,6 volts. This doubled voltage is regulated to 5V using a voltage controller 384 to increase the autonomy of the remote control 374.

The micro-controller 386 is connected to the output of the voltage controller 384. The micro-controller 386 verifies which buttons from the input pad 392 have been depressed and sends the status of the remote control 374 to the RF transceiver 388. The button selection logic 394, affected by the tension level multiplexing, allows the micro-controller 386 to determine which button of the input pad 392 has been depressed.

On the receiver side 376, the transceiver 398 and the antenna 400 are configured to allow communication through airwaves with the transceiver 388 and antenna 390.

The micro-controller 396 of the receiver 376 is configured to receive from the transceiver 398 the status of the buttons of the remote control 374 and to send these information through the coordination bus 302 via the coordination bus interface 340. It is generally the central control system 312 that processes the information receives form the remote control 374 for sending corresponding queries/commands to the motors 84,132, and 184.

Alternatively, it is possible to directly connect the remote control 374 to the micro-controller 396 of the receiver 376 via a RS-232 connector for example.

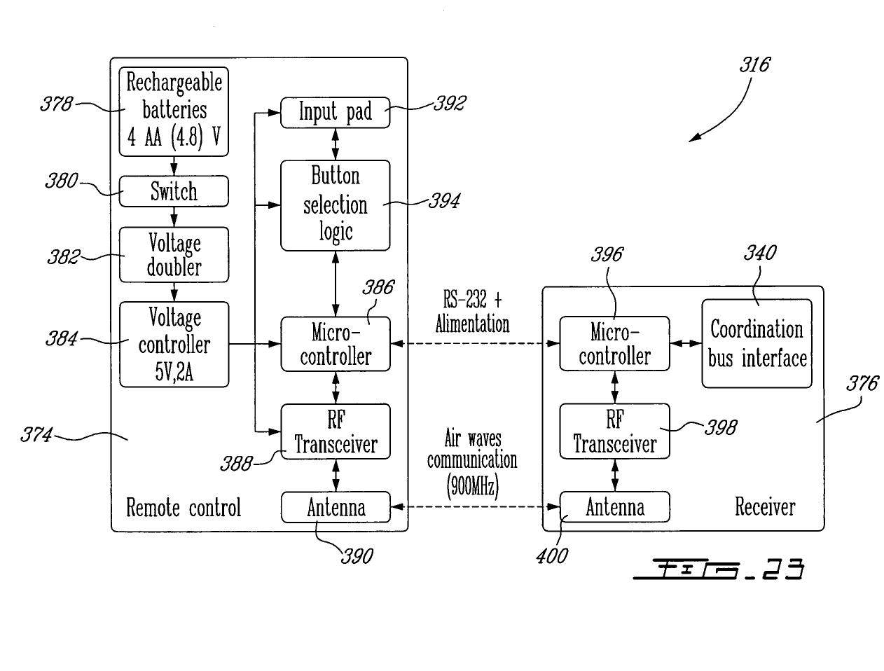

The user-interface system 318 will now be described in more detail with reference to FIG. 24.

The user-interface system 318 allows a user to visualize information related to the robotic platform 10. More specifically, a personal data assistant (PDA) 402, such as a Palm Pilot™ or a Pocket PC™ device, can be coupled to the robot 10.

The PDA 402 is configured to allow a user to visualize the status of the robot 10 or of components or module thereof, including the batteries 66 level, information related to the pitch gauge system 320, current in one of the motors 84, 132, and 184, position of each motor, etc. and/or to modify the operational modes of the robot 10. The PDA 402 is easily programmable to provide configuration screens or to visualize data. It can also be used as a coordination bus console to visualize messages carried by the coordination bus 304.

A PDA connector 404 provides the power supply of the PDA 402 and for the RS-232 or another serial communication port. A 12 V power source is supplied to the PDA connector 404 via a DC/DC regulator 410. The regulator 410 lowers the tension to 5.2 V, which is required to energize and recharge the PDA 404. Of course, other means may be provided to energize the PDA 404.

The micro-controller 408 of the user-interface system 318 is configured to interface with the coordination bus 304 via the coordination bus interface 340 and to manage messages intended to the PDA 402 using filters. The micro-controller 408 also allows the transmission of emergency stop signal for the central control system.

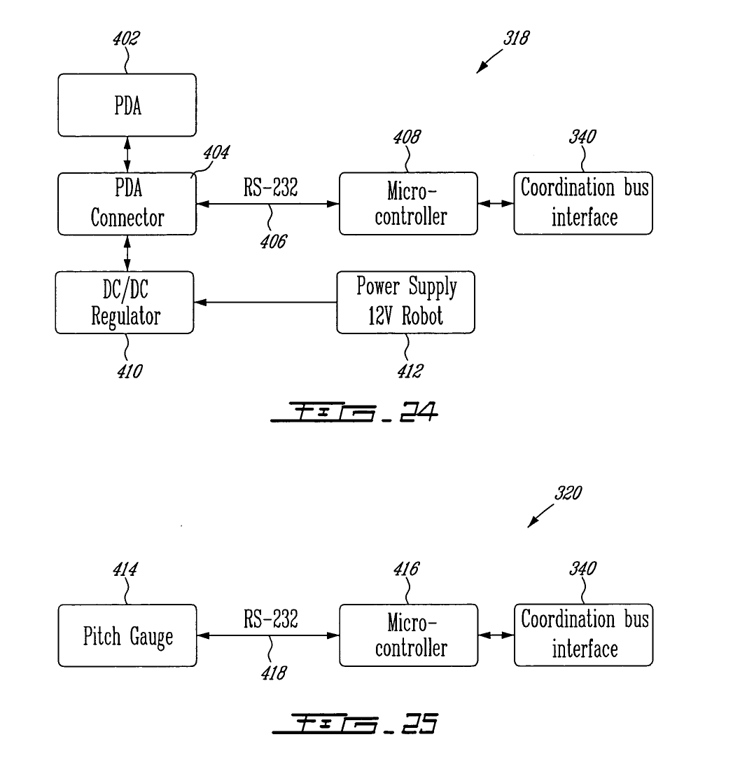

With reference now to FIG. 25, the pitch gauge system 320 comprises a pitch gauge 414 connected to a micro-controller 416 that is connected to the coordination bus 304 via the coordination bus interface 340.

The pitch gauge 414 allows measuring the roll and pitch between the ranges −70 to 70 degrees. The magnetic orientation can also be determined by the pitch gauge 414 over 360 degrees. The pitch gauge 414 allows the robotic platform 10 to navigate on uneven ground such as stairs or rough broken land. The pitch gauge 414 also allows determining the ambient temperature, which can be advantageous to determine if the fan system 54 of the robot 10 works properly.

Since pitch gauge are believed to be well known in the art, it will not be described herein in more detail. Alternatively, the pitch gauge can be replaced by another pitch measuring device such as an inertial system.

The micro-controller 416 acquires readings from the pitch gauge 414 via a RS-232 link or another data communication link and acts as an interface with the coordination bus 304 via the coordination bus interface 340, providing the modules of the robotic platform 10 with the measures of the pitch gauge 414. The queries are issued mainly from the central control system 312 when the robotic platform is in the “flat track operational mode” which will be described hereinbelow in more detail. Queries to the pitch gauge system 320 can also be issued from the user-interface system 318 that displays the pitch gauge readings to a user.

The computer system, 322 will now be described with reference to FIG. 26.

The computer 420 is the heart of the computer system 322. The computer 420 includes Protocol Control Information (PCI) and Industry Standard Architecture (ISA) interfaces and conventional personal computer peripherals 422. Since ISA and PCI interfaces are believed to be well known in the art, they will not be described herein in more detail.

The computer 420 is programmed to communicate with the robotic platform 10 via the coordination bus 304 and to command and control more complex operations than those allowed by the micro-controllers of the different modules of the robotic platform 10.

The DC-DC HE-104 converter 424 supplies in energy all components of the computer system 322 including the Personal Computer Memory Card International Association (PCMCIA) adaptor 426, the image acquisition card 428, the computer 420, etc.

The computer system 322 further includes a PCMCIA adaptor 426 allowing, for example, connecting an 802.11b wireless Ethernet card.

Four cameras (not shown) may be connected to an image acquisition card 428 via the RCA video ports 432. Of course, more cameras can be connected, by adding acquisition cards on the computer 420.

The computer system 322 includes a storing device in the form of a hard drive 430 connected to the computer 420. The storing device can take many form, including, for example, solid-state memory such as compact Flash.

Of course, the computer system 322 may have other configurations.

In operation, the platform 10 is configured to move according to many displacement modes that are rendered possible by the fact that each leg 18 includes three degrees of freedom. Indeed, the robotic platform 10 can pivot horizontally relatively to the body 12, each leg 18 can pivot about the steering assembly 20, and the drive wheel 162 can rotate. Moreover, angular displacements of the legs 18 allow the platform 10 to straddle obstacles and objects and to grip the corners of stairs for climbing. Also, the configuration of the legs 18 allows raising the platform 10 by positioning the driven wheels 164 under the platform 10.

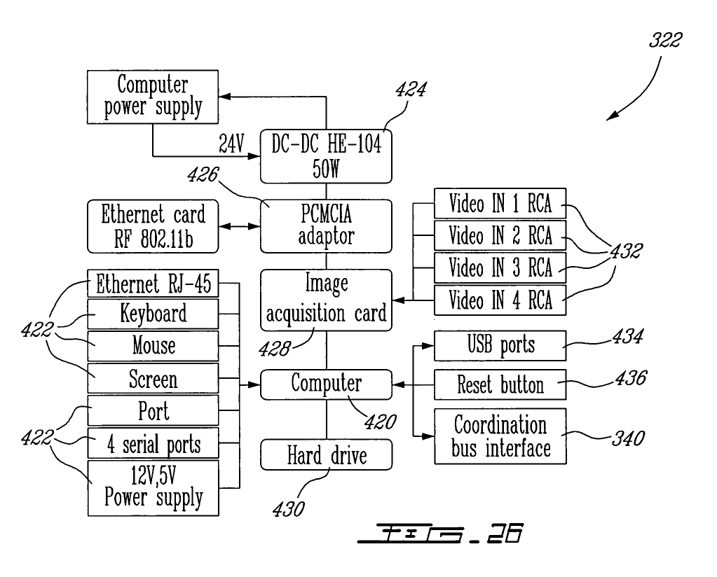

Some of the displacement modes will now be described in more detail. These displacement modes are summarized in FIG. 27. In each of these displacement modes, the legs 18 are positioned differently so as to allow the platform 10 to move differently. As illustrated in FIG. 27, transient states are provided to control the movement of the legs 18 between displacement modes to prevent mechanical collisions. Of course, the robotic platform 10 is not limited to move using one of these displacement modes.

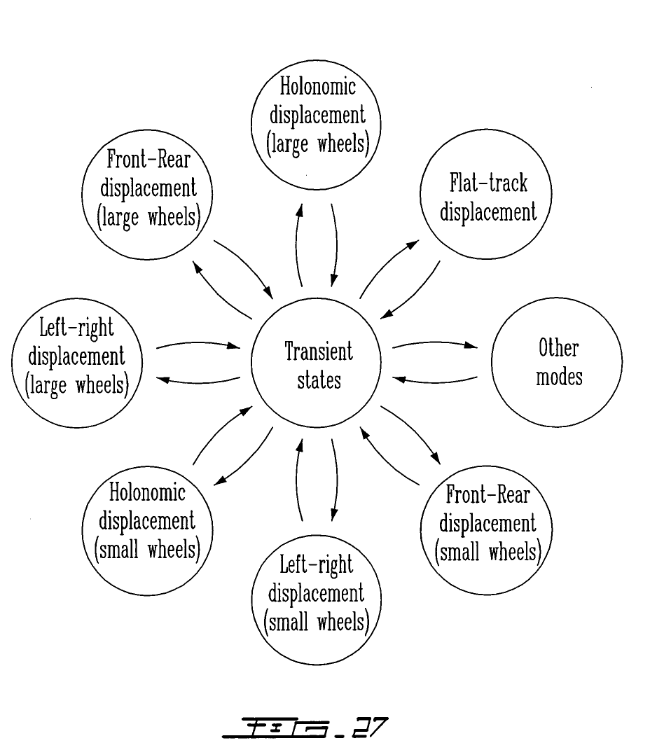

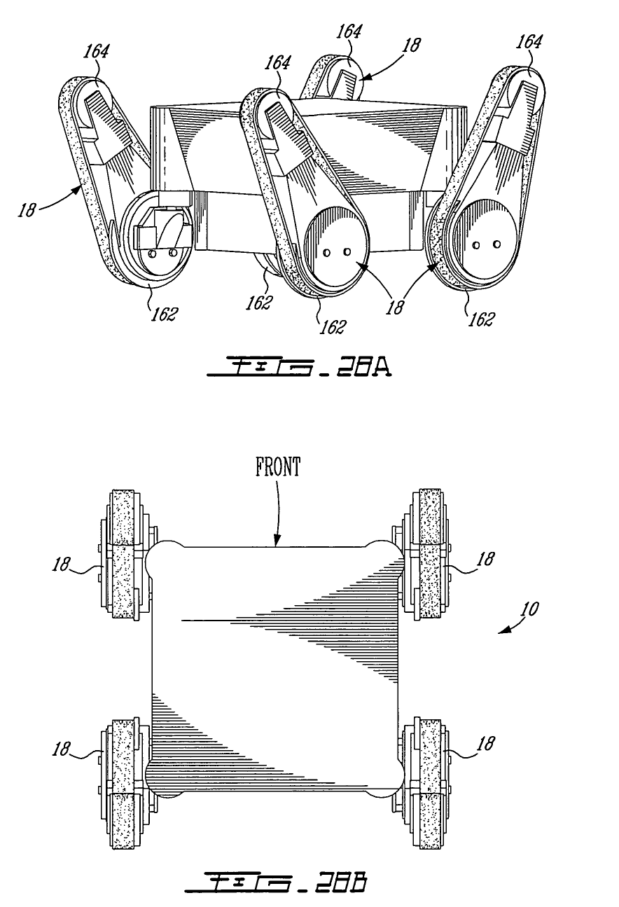

FIGS. 28A-28B illustrate the configuration of the legs 18 to move the platform 10 straight, forward and backward. According to this configuration, the drive wheels 162 are oriented parallel to one another with the driven wheels 164 raised above the drive wheels 162.

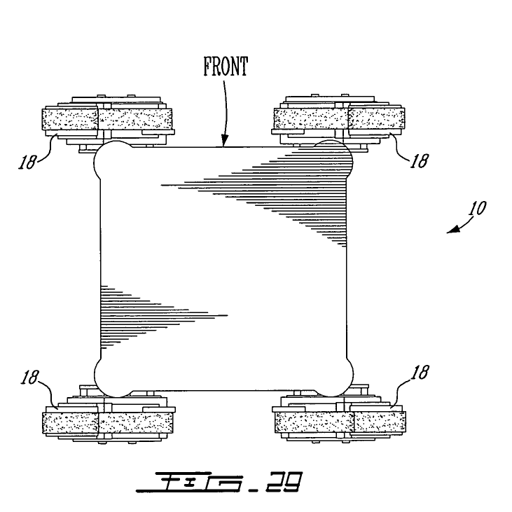

FIG. 29 illustrates the configuration of the legs 18 to move the platform 10 sideways. In this configuration, the legs 18 are aligned with the front and the back of the body 12 with the driven wheels 164 raised above the drive wheels 162.

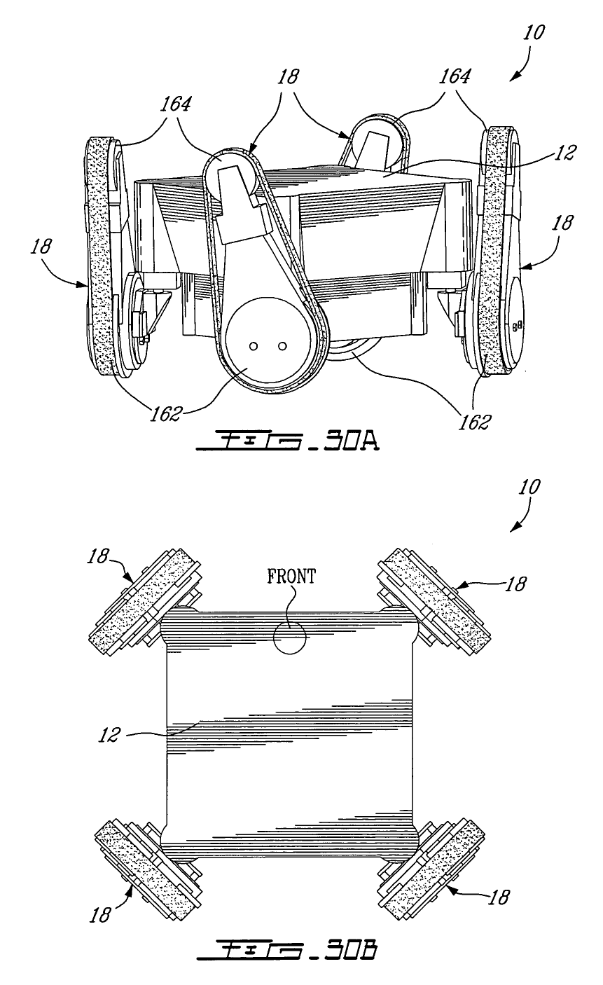

FIG. 30 illustrates the configuration of the legs 18 to allow a pivot movement of the robot platform 10 without translation. According to this configuration, the axle of the steering assembly are aligned with the center of the body 12 and the driven wheels 164 are raised above the drive wheels 162.

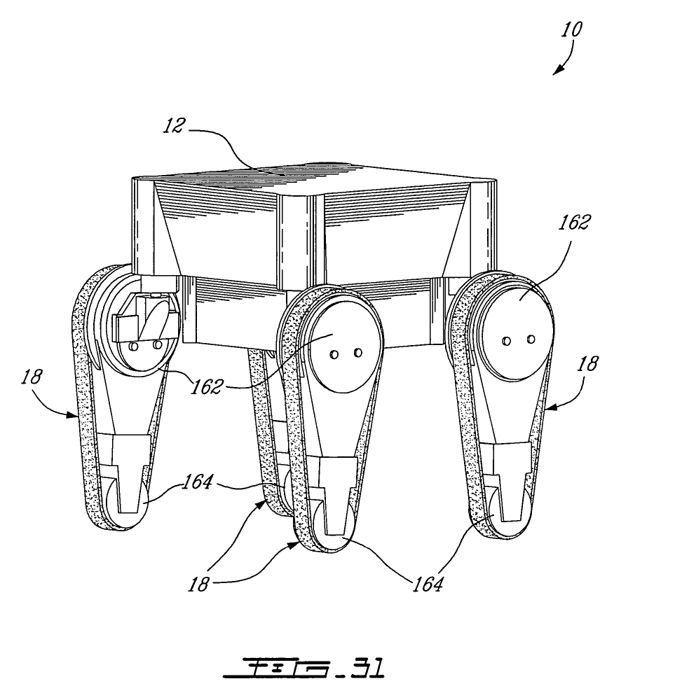

All the above-described displacements can also be performed while the platform 10 is raised, which is achieved by pointing the driven wheels 164 towards the ground. Of course, in this configuration, the driven wheels 164 provide the traction. This configuration is illustrated in FIG. 31.

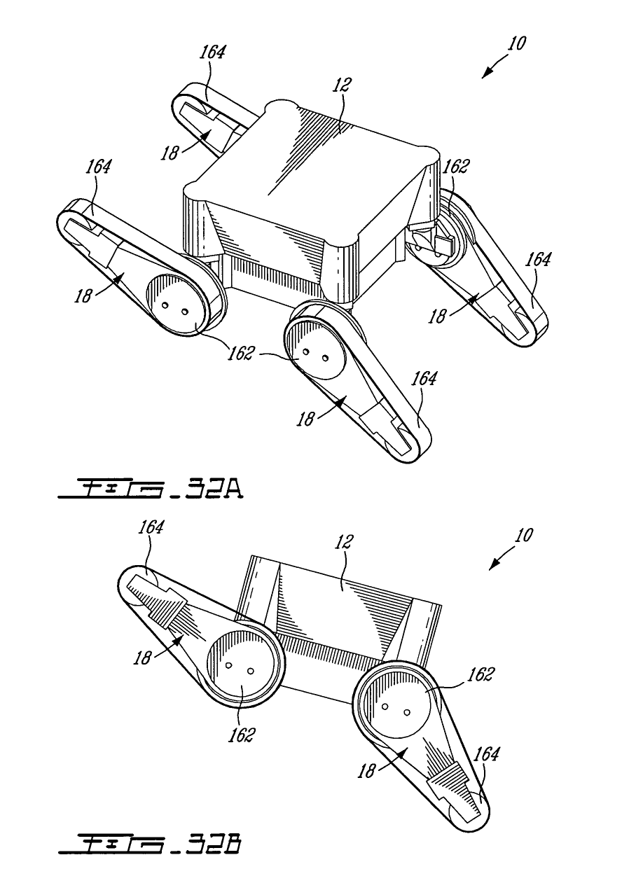

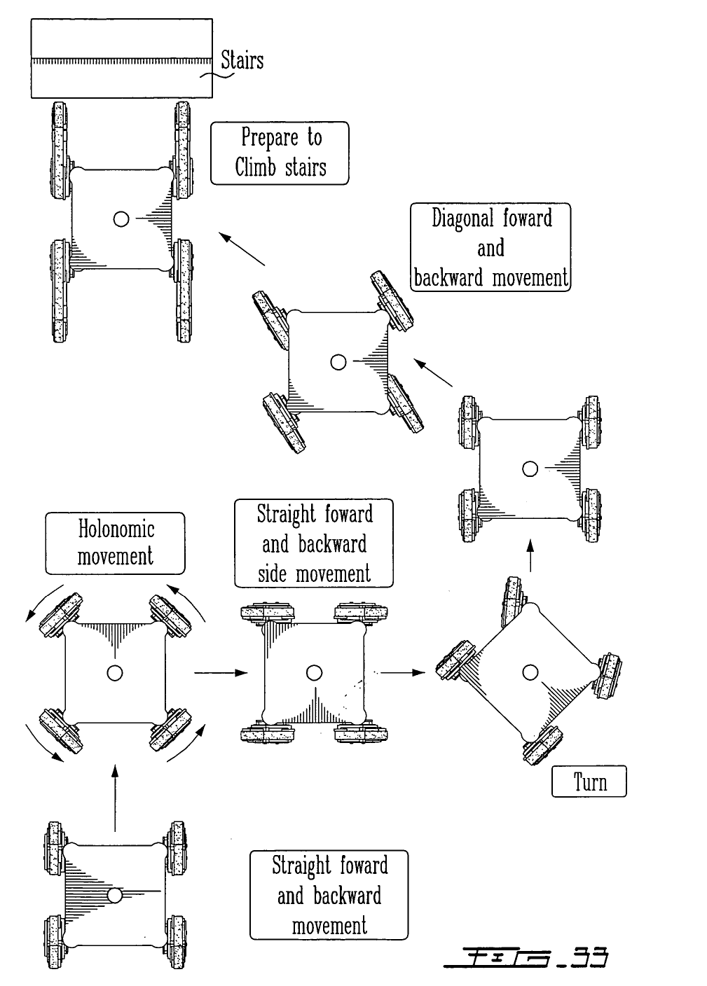

FIG. 32A-32B illustrates the flat-track displacement mode. According to this mode, the driven wheels 164 are generally on the same level than the drive wheels 162 relatively to the surface on which the legs 18 lie. This mode provides a generally continuous plane under the robotic platform 10, allowing the platform 10 climbing stairs smoothly as if it were an inclined plane. To go into this mode, the legs 18 go into a transient mode where the legs 18 lower to provide an angle of approach of about 45 degrees, and then position themselves gradually flat while the stair is being cleared.

Other modes can be defined to achieve specific displacement, such as: passing through narrow spaces, leveling the body 12 when the platform 10 is on an inclined plane, etc. A large variety of movements and configurations are allowed since each leg 18 is individually controlled.

A sequence of displacement and movement of the robotic platform 10 is illustrated in FIG. 33.

It is to be noted that the number and nature of the modules illustrated in FIG. 16 may vary. Indeed, the modularity of the present invention and the use of a communication data bus for communication between the various modules may also be used to control robotic platform having a configuration different than the robotic platform 10. For example, a robotic platform designed for underwater displacement with no other limbs than a propeller and a rudder can take advantage of the modularity of a robotic platform according to the present invention. Also, the architecture of a robotic platform according to the present invention allows also, for example, to replace the legs 18 for regular wheels.

Although the present invention has been described hereinabove by way of preferred embodiments thereof, it can be modified, without departing from the spirit and nature of the subject invention as defined in the appended claims.

What is claimed is:

1. A robotic platform comprising:
a body;
at least two locomotion members for moving said body; each of said at least two locomotion members being mounted to said body via a steering assembly so as to pivot in a first plane relatively to said body; each of said at least two locomotion members including an endless track assembly having a driving wheel, a drive system for driving said driving wheel, a driven wheel, an endless track for coupling said driven wheel to said driving wheel for rotation in unison, and a track tensioning assembly for pivoting said locomotion member in a second plane perpendicular to said first plane;
at least one controller mounted to said body and being coupled to said at least two locomotion members; said at least one controller being configured to actuate the movement of said at least two locomotion members; and
a power supply system mounted to said body and being coupled to said at least one controller for energizing said at least one controller and said at least two locomotion members.

2. A robotic platform as recited in claim 1, comprising four locomotion members.

3. A robotic platform as recited in claim 1, wherein said drive system includes a mounting assembly, and i) a driving wheel actuator, ii) a driving mechanism for said track-tensioning assembly, and iii) a driving wheel support structure mounted to said mounting assembly.

4. A robotic platform as recited in claim 3, wherein said steering assembly includes a pivoting actuator; said at least one controller being configured to control said driving wheel actuator, said driving mechanism for said track-tensioning assembly, and said pivoting actuator.

5. A robotic platform as recited in claim 3, wherein said mounting assembly includes first and second mounting plates secured to one another so as to face each other and as to provide a gap therebetween.

6. A robotic platform as recited in claim 5, wherein said driving wheel actuator includes a motor, having an output driving shaft, mounted to said second mounting plate on a side opposite said first mounting plate so that said output driving shaft extends through said second mounting plate towards said first mounting plate, an internally toothed gear coaxially mounted on said second plate between said first and second plates and being provided with inner toothed gear operatively coupled to the output driving shaft of said motor via a pulley assembly;
whereby, in operation, rotation of the driving shaft causes the rotation of the internally toothed gear.

7. A robotic platform as recited in claim 6, wherein said motor is of the servo-disc type.

8. A robotic platform as recited in claim 3, wherein said driving wheel support structure includes at least three ball bearings for receiving said driving wheel; each said at least three ball bearings being mounted to said first mounting plate near the circumference thereof via rods; said second mounting plates having a width providing with a notch; said driving wheel support structure further including a large diameter bearing mounted between said driving wheel and said second mounting plate so as to abut said notch.

9. A robotic platform as recited in claim 3, wherein said driving mechanism for said track-tensioning assembly includes an inner toothed gear mounted to said track-tensioning assembly, a motor, having a driving shaft and being mounted to said first mounting plate, for driving said inner toothed gear, and a speed-reduction gear set for transmitting the rotational movement of said motor to said inner-toothed gear.

10. A robotic platform as recited in claim 9, wherein said speed-reduction gear set is configured for self-locking said track-tensioning assembly when said motor is stopped.

11. A robotic platform as recited in claim 1, wherein said track-tensioning assembly includes a support frame mounted within said endless track to both said driving wheel and said driven wheel therebetween; said driving wheel being received in a ring portion of said support frame.

12. A robotic platform as recited in claim 11, wherein said tensioning assembly includes a tensioning sub-assembly for adjusting the tension of said endless track.

13. A robotic platform as recited in claim 12, wherein said tensioning sub-assembly includes a driven wheel mounting bracket; said driven wheel being rotatably mounted to said bracket; said driven wheel mounting bracket being mounted to said frame support so as to be selectively movable within said endless track in a direction away from said driving wheel and generally defined by said endless track.

14. A robotic platform as recited in claim 13, wherein said driven wheel mounting bracket being selectively movable via at least one threaded rod and an adjustment rod mounted to both said driven wheel mounting bracket and said support frame therebetween; said adjustment rod including i) a keyway engaged in a corresponding key mounted to said mounting bracket and ii) a threaded portion at its longitudinal end opposite said keyway; said threaded portion of said adjustment rod including an adjustment bolt abutting a plate secured to said support frame;
whereby, in operation, rotation of said adjustment bolt allows moving said driven wheel mounting bracket away or towards said driving wheel.

15. A robotic platform as recited in claim 11, wherein said tensioning assembly includes two skid plates mounted transversally to said support frame on opposite lateral sided thereof for supporting said endless track.

16. A robotic platform as recited in claim 1, wherein said driving wheel is larger than said driven wheel.

17. A robotic platform as recited in claim 1, wherein said driven wheel is larger than said driving wheel.

18. A robotic platform as recited in claim 1, wherein said driving wheel includes a protective disk mounted on a peripheral surface thereof; said protective disk extending radially from said driving wheel.

19. A robotic platform as recited in claim 18, wherein said protective disk is covered by a coating.

20. A robotic platform as recited in claim 1, wherein each of said at least two locomotion members includes a locomotion controller for actuating said drive system of said each of said at least two locomotion member.

21. A robotic platform as recited in claim 1, wherein each of said at least two locomotion members includes at least one position sensor for measuring displacements of said at least two locomotion members.

22. A robotic platform as recited in claim 1, further comprising an environment recognition module including at least one of a proximity sensor and a long-range sensor mounted to said locomotion member and coupled to said controller; readings from said at least one of a proximity sensor and a long-range sensor being usable by said controller to control said at least two locomotion members.

23. A robotic platform as recited in claim 1, further comprising an environment recognition module including at least one of an ultra-sound sensor and an infrared sensor.

24. A robotic platform as recited in claim 1, further comprising at least one environment recognition module, each mounted on one of said at least two locomotion members.

25. A robotic platform as recited in claim 1, wherein said body includes a chassis.

26. A robotic platform as recited in claim 25, wherein said steering assembly is mounted to said chassis.

27. A robotic platform as recited in claim 26, wherein said steering assembly includes work reducing means providing a lever effect between said chassis and said locomotion member.

28. A robotic platform as recited in claim 26, wherein said steering controller includes pivot-controlling means.

29. A robotic platform as recited in claim 26, wherein said steering assembly includes a motor secured to said chassis via a motor bracket.

30. A robotic platform as recited in claim 29, wherein said steering assembly further includes a worm-gear having an input operatively coupled to said motor and an output operatively coupled to a drive shaft rotatably mounted to said chassis, a gear box having a first gear fixedly mounted to said drive shaft and cooperatively coupled to a second gear, and a locomotion member mounting bracket for receiving one of said at least two locomotion members and being fixedly mounted to a rotatable shaft mounted to said second gear.

31. A robotic platform as recited in claim 30, wherein at least one of said motor, said worm-gear, and said gear box being configured so as to yield a reduction of speed between said motor and said locomotive assembly mounting bracket.

32. A robotic platform as recited in claim 25, wherein said body includes columns mounted on said chassis.

33. A robotic platform as recited in claim 32, wherein said body further includes a mounting plate mounted on top of said chassis via said columns; said mounting plate allowing receiving equipments to be carried by the robotic platform.

34. A robotic platform as recited in claim 32, further comprising handles secured to said columns.

35. A robotic platform as recited in claim 25, further comprising at least one interface panel secured to said chassis and connected to said at least one controller.

36. A robotic platform as recited in claim 25, further comprising a shell mounted unto said chassis.

37. A robotic platform as recited in claim 36, wherein said shell includes shell portions; each said shell portions being removably secured to said chassis so as to selectively allow access to internal parts of said body.

38. A track-tensioning assembly for pivoting an endless track assembly including a driving wheel about the driving wheel; said endless track assembly including, in addition to the driving wheel, a drive system for driving the driving wheel, a driven wheel, and an endless track for coupling the driven wheel to the driving wheel for rotation in unison; the track-tensioning assembly comprising:
a support frame having a ring portion and being mounted within the endless track between said driving wheel and said driven wheel; said driving wheel being rotatably received in said a ring portion of said support frame;
a driving mechanism for pivoting said support frame about said driving wheel, including an inner toothed gear secured to said support frame, a motor, having a driving shaft, mounted to the driving wheel via a mounting plate for driving said inner toothed gear, and a speed-reduction gear set for transmitting the rotational movement of said driving shaft of said motor to said inner-toothed gear.

39. A track-tensioning assembly as recited in claim 38, wherein said speed-reduction gear set is configured for self-locking said track-tensioning assembly when said motor is stopped.

40. A track-tensioning assembly as recited in claim 38, wherein said tensioning assembly includes a tensioning sub-assembly for adjusting the tension of said endless track.

41. A track-tensioning assembly as recited in claim 40, wherein said tensioning sub-assembly includes a driven wheel mounting bracket; said driven wheel being rotatably mounted to said bracket; said driven wheel mounting bracket being mounted to said frame support so as to be selectively movable within the endless track in a direction away from the driving wheel and generally defined by the endless track.

42. A robotic platform comprising:
a body;
a locomotion assembly mounted to said body for moving said body; said locomotion assembly including at least one locomotion member for displacement of said body and a steering assembly including a steering mechanism for steering said body; said at least one locomotion member including a drive assembly and a locomotion controller coupled to said drive assembly; said steering assembly including a steering controller coupled to said steering mechanism;
an environment recognition module mounted to the platform for gathering environment data indicative of the environment surrounding the robotic platform; said environment recognition module including a sensor and a recognition module controller coupled to said sensor;
an energizing module including a power supply controller and an energizing system connected to said locomotion assembly and said environment recognition module for energizing said locomotion assembly and said environment recognition module; and
a communication data bus interconnecting said at least one locomotion controller, said steering controller and said environment recognition module controller for communicating status data therebetween;
whereby, in operation, said locomotion controller, steering controller, recognition module controller, and power supply controller exchanging status data about said drive assembly, said steering assembly, said environment recognition module, and said energizing system via said communication data bus, and using said status data to control said drive assembly, said steering assembly, said environment recognition module, and said energizing system respectively.

43. A robotic platform as recited in claim 42, wherein said steering controller is coupled to said steering mechanism via a sensor mounted to said steering mechanism; said sensor being coupled to said steering controller.

44. A robotic platform as recited in claim 42, wherein said locomotion controller is coupled to said drive assembly via a sensor mounted to said drive assembly; said sensor being coupled to said locomotion controller.

45. A robotic platform as recited in claim 42, further comprising a central control system, coupled to said locomotion controller, said steering controller and said recognition module controller, for receiving status data about said drive assembly, said steering assembly, said environment recognition module, and said energizing system via said communication data bus, and using said status data for coordinating and selectively controlling said drive assembly, said steering assembly, said environment recognition module, and said energizing system so as to achieve at least one predetermined operational mode.

46. A robotic platform as recited in claim 45, wherein selectively controlling said drive assembly, said steering assembly, said environment recognition module, and said energizing system includes sending query messages to said environment recognition module via said communication data bus, and receiving distance evaluation from said environment recognition module.

47. A robotic platform as recited in claim 45, wherein selectively controlling said drive assembly, said steering assembly, said environment recognition module, and said energizing system includes sending query messages to said at least one locomotion controller via said communication data bus, receiving data from said locomotion member indicative of said locomotion member configuration, and sending command messages to control said at least one locomotion member according to said data indicative of said locomotion member configuration.

48. A robotic platform as recited in claim 45, wherein said at least one locomotion member includes at least two locomotion members each coupled to a locomotion controller and to a steering controller yielding at least two locomotion controllers and at least two steering controllers; said robotic platform further comprising a synchronisation data bus interconnecting the at least two locomotion controllers and the at least two steering controllers of said at least two locomotion members to said central controller; said central controller being configured for receiving status data from said at least two locomotion controllers and said at least two steering controllers of said at least two locomotion members and for controlling said at least two locomotion controllers and said at least two steering controllers of said at least two locomotion members.

49. A robotic platform as recited in claim 42, wherein said environment recognition module includes at least one of a proximity sensor and a long-range sensor.

50. A robotic platform as recited in claim 42, wherein said environment recognition module includes at least one of an ultra-sound sensor, an infrared sensor and a contact switch.

51. A robotic platform as recited in claim 50, wherein said contact switch is mounted to said body.

52. A robotic platform as recited in claim 42, wherein said environment recognition module includes at least one sensor mounted to said at least one locomotion member.

53. A robotic platform as recited in claim 42, wherein said at least one locomotion member includes at least one position sensor for measuring displacements of said at least one locomotion member.

54. A robotic platform as recited in claim 53, wherein said at least one position sensor includes a position encoder or a limit switch.

55. A robotic platform as recited in claim 42, wherein said body includes a chassis.

56. A robotic platform as recited in claim 55, wherein said steering assembly is mounted to said chassis.

57. A robotic platform as recited in claim 56, wherein said steering assembly includes a motor secured to said chassis via a bracket.

58. A robotic platform as recited in claim 42, wherein steering controller includes pivot controlling means.

59. A robotic platform as recited in claim 42, wherein said at least one locomotion member includes a plurality of locomotion members; said communication data bus including a synchronisation data bus for communicating information related to the synchronisation of said plurality of locomotion members.

60. A robotic platform as recited in claim 42, wherein said communication data bus allows for the exchange of queries and data between said at least one locomotion controller, said steering controller, and said recognition module controller.

61. A robotic platform as recited in claim 42, wherein said at least one locomotion controller, said steering controller and said recognition module controller communicate via said communication data bus using the Control Area Network (CAN) protocol.

62. A robotic platform as recited in claim 61, wherein the version 2.0B of said CAN protocol is used.

63. A robotic platform as recited in claim 61, wherein said at least one locomotion controller, said steering controller and said recognition module controller communicate via said communication data bus using CAN data frame including an arbitration field characterized by at least one of a priority, a message type, a command or query, and a hardware address indicative of a module identity.

64. A robotic platform as recited in claim 63, wherein said message type is used for a receiving module filtering frames and includes at least one of emergency query, high-priority actuator, high-priority sensor low-priority actuator, and low-priority sensor.

65. A robotic platform as recited in claim 42, wherein said locomotion controller and said steering controller are the same.

66. A robotic platform as recited in claim 42, wherein said energizing system includes at least one power source selected form the group consisting of a battery, a battery pack, a fuel cell.

67. A robotic platform as recited in claim 42, further comprising a pitch gauge system mounted to said body for measuring the pitch of said body and including a pitch measuring device and a pitch device micro-controller connected to said communication data bus and coupled to said pitch device.

68. A robotic platform as recited in claim 67, wherein said pitch measuring device is a pitch gauge or an inertial system.

69. A robotic platform as recited in claim 42, further comprising a user-interface to be coupled to the robotic platform via the communication data bus for accessing data information related to said locomotion controller, steering controller, recognition module controller, and said power supply controller.

70. A robotic platform as recited in claim 42, further comprising a computer system configured to communicate with said locomotion controller, said steering controller, said recognition module controller, and said power supply controller via the communication data bus and to control said locomotion controller, steering controller, recognition module controller, and said power supply controller.

71. A method for controlling the modules of a robotic platform, each module including a system and a controller for the system, and each system including at least one sensor and one actuator, the method comprising:
coupling the modules through a communication data bus;
providing a central controller coupled to the modules via the communication data bus;
upon one of the modules sending a first data frame over said communication data bus, each said first data frame being characterized by the hardware address of the module to which the data frame is intended;
i) each of the modules filtering said first data frame to identify data frames intended thereto using said hardware address of the module to which said first data frame is intended;
ii) said central controller verifying whether the module to which said first data frame is intended to is activated or not;
iii) if said module to which said first data frame is intended to is activated then said module to which the data frame is intended to a) reading its at least one sensor, b) processing said command or query according to said reading, c) commanding its at least one actuator according to said processing, and d) transmitting a second data frame via said communication bus to the modules indicative of the command/query; and
iv) transmitting a second data frame indicative of the status of at least said module to which said first data frame is intended to.
